(19) United States
(12) Patent Application Publication
(10) Pub. No.: US 2026/0282198 A1
(43) Pub. Date: Sep. 17, 2026

(54) LIGHTING SYSTEM CONTROL VIA AC POWER LINES

(71) Applicant: DMF, Inc., Carson, CA (US)

(72) Inventors: Russikesh Kumar, Ridgewood, NJ (US); Ketan Lakhera, Huntington Beach, CA (US); Oren Kashani, Kfar Saba (IL)

(73) Assignee: DMF, Inc., Carson, CA (US)

(21) Appl. No.: 19/672,185

(22) Filed: May 8, 2026

Related U.S. Application Data
(63) Continuation of application No. 19/559,322, filed on Mar. 6, 2026.
Application No. 19/559,322 is a continuation of application No. PCT/US2024/049831, filed on Oct. 3, 2024.
(60) Provisional application No. 63/587,607, filed on Oct. 3, 2023.

(51) Int. Cl. H05B 47/185

(52) U.S. Cl. CPC H05B 47/185

(57) ABSTRACT

A gateway controls a portion of lighting fixtures within a lighting system in response to a first digital signal and comprises a power input port to receive AC power, a power line filter to filter electrical noise from the received AC power, a power output port to output the filtered AC power to the portion of lighting fixtures, an input signal port to receive the first digital signal, an output signal port to pass the received first digital signal to a second gateway, a local controller, a first transceiver coupled to the input signal port to receive the first digital signal, and a second transceiver coupled to the power output port to couple the second digital signal to the power output port.

### CROSS-REFERENCE TO RELATED APPLICATIONS

This application is a continuation of U.S. application Ser. No. 19/559,322, filed Mar. 6, 2026, titled “Lighting System Control Via AC Power Lines,” which is a bypass continuation application of international application PCT/US2024/049831, filed Oct. 3, 2024, titled “Lighting System Control Via AC Power Lines with Distributed Gateways,” which application claims a priority benefit, under 35 U.S.C. § 119 (e), of U.S. Application No. 63/587,607, filed on Oct. 3, 2023 titled, “Lighting System Control Via AC Power Lines.” Each of these applications is incorporated herein by reference in its entirety.

### BACKGROUND

Conventional control for residential and commercial lighting typically includes AC dimmers to control lighting intensity of one or more lights on a power line. The AC dimmers typically occupy most of the space in a standard, single-gang, wall-mounted, light-switch junction box (which measures about 2 inches wide by about 4 inches height by about 2 inches depth). Such dimmers are based on phase-cut technology. To control many lights differently from a single location, a substantially larger box is required for a plurality of dimmers, and it is no longer possible to mount the dimmers and central control in an inconspicuous location within a room or facility.

### SUMMARY

Small gateways, sized to fit in single-gang junction boxes, can be used to couple digital control signals onto AC power lines carrying filtered AC power to power and control compliant lighting fixtures on the power lines in one or more groups (or zones) of lighting. The control signals can be received from a system controller or other source. A gateway can also be used to control each lighting fixture on its connected power line independently of other lighting fixtures on the power line. The gateway (which can control up to 100 lighting fixtures on a single AC power line) can fit within a junction box so that the gateway can be inconspicuous in a room or facility. A plurality of the gateways can be daisy-chained together to control a large number of compliant lighting fixtures and other compliant devices (fans, heaters, etc.) as desired in a commercial or residential facility. The lighting fixtures and compliant devices can be located indoors and/or outdoors. Signaling errors that would occur due to nulls in communication links can be avoided using multiple carrier wave frequencies and/or repeater action implemented by some of the lighting fixtures.

Some implementations relate to a first gateway to control a portion of lighting fixtures within a lighting system, the first gateway installable within the lighting system to receive a first digital signal and control at least one lighting fixture of the portion of lighting fixtures in response to the first digital signal. The first gateway comprises: a power input port to receive AC power from a power source for the lighting system; a power output port to output filtered AC power to one or more lighting fixtures; a power line filter coupled between the power input port and the power output port to filter electrical noise from the received AC power and provide the filtered AC power to the power output port; an input signal port to receive a first digital signal; a local controller; a first transceiver communicatively coupled to the local controller, wherein the first transceiver is configured to receive the first digital signal from the input signal port; and a second transceiver to couple a second digital signal to the power output port, wherein the second transceiver is communicatively coupled to the local controller, wherein the local controller is configured to activate the second transceiver to couple the second digital signal to the power output port to control the at least one lighting fixture in response to receipt of the first digital signal.

Some implementations relate to methods of operating the gateway in a lighting system comprising: a system controller; a power source; and a gateway coupled to the power source and communicatively coupled between the system controller and a portion of lighting fixtures in the lighting system to be controlled by the gateway. Such methods can include acts of: receiving AC power from the power source at a power input port of the gateway; filtering electrical noise from the received AC power with a power line filter coupled to the power input port; outputting filtered AC power to a power output port of the gateway to power the portion of lighting fixtures; receiving a first digital signal at an input signal port of the gateway; passing the received first digital signal to an output signal port communicatively coupled to the input signal port at the gateway; and coupling a second digital signal to the power output port in response to receiving the first digital signal to control at least one lighting fixture of the portion of lighting fixtures.

Some implementations relate to a first gateway to control a portion of lighting fixtures within a lighting system, the first gateway installable within the lighting system to receive a first digital signal and control at least one lighting fixture of the portion of lighting fixtures in response to receipt of the first digital signal. The first gateway comprises: a power input port to receive AC power; a power line filter coupled to the power input port to filter electrical noise from the received AC power thereby producing filtered AC power when the first gateway is operating in the lighting system; a power output port to output the filtered AC power to the portion of lighting fixtures; an input signal port to receive the first digital signal; and an output signal port communicatively coupled to the input signal port to pass the received first digital signal to a second gateway, wherein the first gateway is configured to couple a second digital signal to the power output port in response to receiving the first digital signal to control the at least one lighting fixture of the portion of lighting fixtures.

Some implementations relate to a first gateway and a second gateway for a lighting system, the first gateway comprises: a first power input port to receive first AC power; a first power line filter coupled to the first power input port to filter electrical noise from the received first AC power thereby producing first filtered AC power when the first gateway is operating; a first power output port to output the first filtered AC power to a first portion of lighting fixtures of the lighting system; a first input signal port to receive a first digital signal from a controller; and a first output signal port communicatively coupled to the first input signal port to pass the received first digital signal to the second gateway, wherein the first gateway is configured to couple a second digital signal to the first power output port in response to receiving the first digital signal to control at least one lighting fixture of the first portion of lighting fixtures. The second gateway comprises: a second power input port to receive second AC power; a second power line filter coupled to the second power input port to filter electrical noise from the received second AC power thereby producing second filtered AC power when the second gateway is operating; a second power output port to output the second filtered AC power to a second portion of lighting fixtures of the lighting system; a second input signal port to receive the first digital signal passed from the first gateway; and a second output signal port communicatively coupled to the second input signal port to pass the received first digital signal to a third gateway, wherein the second gateway is configured to couple a third digital signal to the second power output port in response to receiving the first digital signal to control at least one lighting fixture of the second portion of lighting fixtures.

Some implementations relate to methods of operating a first portion of lighting fixtures and a second portion of lighting fixtures within a lighting system. Such methods can comprise acts of: receiving, at a first gateway installed within the lighting system, AC power at a first power input port, the AC power sufficient to power at least the first portion of lighting fixtures; filtering, with a first power line filter, electrical noise from the AC power to produce first filtered AC power; receiving, at the first gateway, a first digital signal at a first input signal port of the first gateway; passing the first digital signal to an output signal port of the first gateway; outputting, from the first gateway, the first filtered AC power to a first AC power line to power the first portion of lighting fixtures; coupling, by the first gateway, a second digital signal onto the first AC power line to control at least one lighting fixture of the first portion of lighting fixtures; receiving, at a second gateway, AC power passed from the first gateway; receiving, at the second gateway, the first digital signal transmitted from the output signal port of the first gateway; filtering, with a second power line filter at the second gateway, electrical noise from the AC power passed from the first gateway to produce second filtered AC power; outputting, from the second gateway, the second filtered AC power to a second AC power line to power the second portion of lighting fixtures in the lighting system; and coupling, by the second gateway, a third digital signal onto the second AC power line to control at least one lighting fixture of the second portion of lighting fixtures.

Some implementations relate to methods to identify a preferred communication channel between the first lighting fixture and the gateway in a lighting system comprising a plurality of lighting fixtures and a gateway to control a portion of lighting fixtures from among the plurality of lighting fixtures, wherein the gateway is configured to receive a first digital signal at an input signal port and couple a second digital signal to a power output port of the gateway in response to receiving the first digital signal to control at least a first lighting fixture of the portion of lighting fixtures, the power output port configured to provide AC power to the portion of lighting fixtures. Such methods can comprise acts of: tuning, by a local controller installed at the first lighting fixture, a transceiver installed at the first lighting fixture to a first communication channel comprising a first carrier wave frequency; determining, by the local controller, first communication error statistics for the first communication channel; when the first communication error statistics are below a threshold value, identifying, by the local controller, the first communication channel as a first candidate communication channel; storing, by the local controller, a first value based on the first communication error statistics; tuning, by the local controller, the transceiver to a second communication channel comprising a second carrier wave frequency different from the first carrier wave frequency; determining, by the local controller, second communication error statistics for the second communication channel; when the second communication error statistics are below the threshold value, identifying, by the local controller, the second communication channel as a second candidate communication channel; storing, by the local controller, a second value based on the second communication error statistics; selecting, by the local controller, the first communication channel or the second communication channel as a preferred communication channel for the first lighting fixture based, at least in part, on the first value and the second value; identifying, by the local controller, the preferred communication channel to the gateway; and transmitting, by the first lighting fixture, an identifier for the first lighting fixture to the gateway.

Some implementations relate to methods to communicate with a portion of lighting fixtures using a plurality of communication channels in a lighting system comprising a plurality of lighting fixtures and a gateway to control the portion of lighting fixtures from among the plurality of lighting fixtures, wherein the gateway is configured to receive a first digital signal at an input signal port and couple a second digital signal to a power output port of the gateway in response to receiving the first digital signal to control at least a first lighting fixture of the portion of lighting fixtures, the power output port configured to provide AC power to the portion of lighting fixtures. Such methods can include acts of: receiving, by the gateway, the first digital signal for a first lighting fixture of the portion of lighting fixtures; determining, from memory at the gateway, a first preferred communication channel for the first lighting fixture; tuning, by the gateway, a transceiver of the gateway to a first carrier wave frequency identified for the first preferred communication channel; coupling, by the gateway, the second digital signal using the first carrier wave frequency; transmitting, by the gateway, the second digital signal to the first lighting fixture; strobing, by the gateway, the plurality of communication channels by tuning the transceiver to different carrier wave frequencies associated with each communication channel of the plurality of communication channels; while strobing the plurality of communication channels, receiving, by the gateway, a request from a second lighting fixture of the portion of lighting fixtures to communicate with the gateway on a second preferred communication channel of the plurality of communication channels; operating, by the gateway, the transceiver at a second carrier wave frequency identified for the second preferred communication channel; and receiving, by the gateway, information from the second lighting fixture using the second preferred communication channel.

Some implementations relate to methods to discover each lighting fixture of the portion of lighting fixtures connected to the power output port of a gateway in a lighting system comprising a plurality of lighting fixtures and the gateway to control a portion of lighting fixtures from among the plurality of lighting fixtures, wherein the gateway is configured to receive a first digital signal at an input signal port and couple a second digital signal to a power output port of the gateway in response to receiving the first digital signal to control at least a first lighting fixture of the portion of lighting fixtures, the power output port configured to provide AC power to the portion of lighting fixtures. Such methods can include acts of: receiving, by the gateway, a first unique identifier from a first lighting fixture of the portion of lighting fixtures; storing, by the gateway, the first unique identifier in memory at the gateway to identify the first lighting fixture as belonging to the portion of lighting fixtures; and tasking, by the gateway, the first lighting fixture with a discovery repeater action, wherein the discovery repeater action comprises: receiving, by the first lighting fixture, a second unique identifier transmitted from a second lighting fixture of the portion of lighting fixtures, wherein the second unique identifier was not detected by the gateway; and transmitting the second unique identifier to the gateway to identify the second lighting fixture to the gateway.

Some implementations relate to a lighting system comprising: a first gateway to control a portion of lighting fixtures within a lighting system, the first gateway installable within the lighting system to receive a first digital signal and control at least a first lighting fixture of the portion of lighting fixtures in response to receipt of the first digital signal. The first gateway comprises: a power input port to receive AC power; a power line filter coupled to the power input port to filter electrical noise from the received AC power thereby producing filtered AC power when the first gateway is operating; a power output port to output the filtered AC power to power the portion of lighting fixtures; an input signal port to receive the first digital signal; an output signal port communicatively coupled to the input signal port to pass the first digital signal to a second gateway; a first controller configured to control, at least in part, operation of the first gateway, wherein the first gateway is configured to couple a second digital signal to the power output port in response to receiving the first digital signal to control at least the first lighting fixture of the portion of lighting fixtures; a first transceiver (440) coupled to the input signal port to receive the first digital signal; and a second transceiver (444) coupled to the power output port to couple the second digital signal to the power output port. The lighting fixture of the lighting system comprises: a light source; a driver configured to receive the filtered AC power on an AC power line and output power to drive the light source; a third transceiver configured to receive the second digital signal from the AC power line; and a second controller communicatively coupled to the third transceiver and the driver, wherein the second controller is configured to operate the driver in response to the second digital signal so that the light source outputs a desired lighting characteristic.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1 depicts a lighting system for LED lighting fixtures that can be controlled over power lines using distributed gateways.

FIG. 2 is a block diagram that depicts an example of an LED lighting fixture that can be used in the lighting system of FIG. 1.

FIG. 3A is a circuit schematic for a local controller and a power line carrier transceiver that can be used in the lighting fixture of FIG. 2.

FIG. 3B is a circuit schematic for a near-field communication circuit that can be used in the lighting fixture of FIG. 2.

FIG. 3C is a circuit schematic of a flyback power supply that can be used to convert AC power to DC power in the lighting fixture of FIG. 2.

FIG. 3D is a circuit schematic for a step-down power supply that can be used in the lighting fixture of FIG. 2.

FIG. 3E is a circuit schematic for an LED driver circuit that can be used in the lighting fixture of FIG. 2.

FIG. 4A is a block diagram of a gateway that can be used to control lighting fixtures in the lighting system of FIG. 1.

FIG. 4B is a circuit schematic for a local controller and a power line carrier transceiver that can be used in the gateway of FIG. 4A.

FIG. 4C is a circuit schematic showing AC power filtering at a power input port and digital signal coupling onto a power output port for the gateway of FIG. 4A.

FIG. 4D is a circuit schematic showing a second transceiver in the gateway of FIG. 4A. The second transceiver can be used for communications with the system controller and/or between gateways in the lighting system of FIG. 1.

FIG. 5A depicts a user interface that can be included at the gateway of FIG. 4A.

FIG. 5B illustrates circuitry associated with the user interface of FIG. 5A.

FIG. 5C illustrates circuitry associated with the user interface of FIG. 5A.

FIG. 6 illustrates example acts of a method to determine a preferred communication channel by a lighting fixture for the lighting system of FIG. 1.

FIG. 7 illustrates example acts of a method for a gateway to communicate with lighting fixtures on a power line connected to a gateway using different communication channels for the lighting system of FIG. 1.

FIG. 8 illustrates example acts of a method to discover lighting fixtures on a power line connected to a gateway in the lighting system of FIG. 1.

### DETAILED DESCRIPTION

1. Lighting System with Control of Lighting Fixtures Over Power Lines

The inventor has recognized and appreciated that providing intensity and color temperature control for multiple lighting fixtures in a room or facility can result in complicated wiring and/or large control boxes. For example, when phase-cut dimmers are used to independently control intensity of many different lighting fixtures in a facility, the control box can become much larger than standard junction boxes and cannot be mounted inconspicuously in a junction box at a facility. For example, the control box can occupy as much as 30 inches by 15 inches in width and height of a 4-inch-deep cabinet. Thus, an installer must determine a suitable location for the control box that is acceptable to the user. Although color temperature control can be implemented in addition to intensity control using phase-cut technology, providing both color temperature control and intensity control for a large number of lights can be challenging. To control a large number of lights independently of one another with phase-cut control, multiple “home run” wires are needed to provide independent lighting control since the phase cut dimmers cannot be daisy-chained together. The inventor has further recognized and appreciated that retrofitting older wiring systems to enable independent lighting control limits all lights on one power line to be controlled in the same way (i.e., not independently of one another).

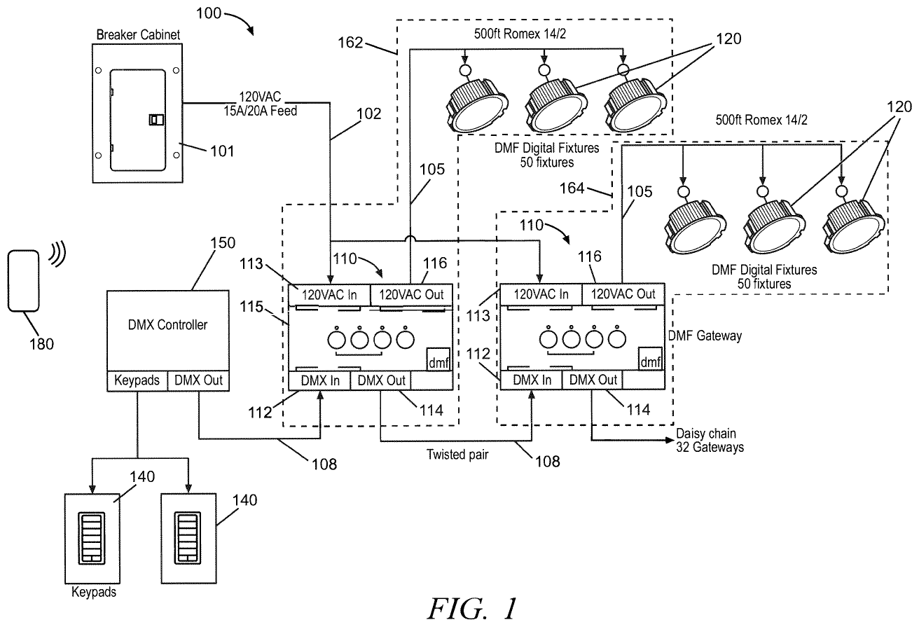

FIG. 1 depicts a lighting system 100 for LED lighting fixtures 120 wherein the lighting fixtures can be controlled over AC power lines. The lighting system 100 can provide independent intensity and color temperature control for each lighting fixture 120 on a single AC power line 105, which can supply power and control signals for up to 100 lighting fixtures on the power line 105. The lighting system 100 includes one or more gateways 110 distributed in the lighting system 100 and configured to receive AC power from a power source 101 and output AC power onto each gateway's connected output AC power line 105. Each gateway 110 is further configured to at least receive digital control signals from a system controller 150. Each gateway 110 can also output digital control signals onto its output AC power line 105 for controlling connected lighting fixtures 120. A gateway 110 can further be configured to output the received digital control signals to another gateway 110 so that the gateways can be daisy-chained together in a facility.

Each gateway 110 can receive AC power at a power input port 113 from a power source 101 (such as a junction box, panel box, breaker box, or another gateway). When AC power is received from another gateway, the power essentially taps off an input to the previous gateway such that AC power is provided in parallel to the coupled gateways, as is the case for the first gateway 110 and second gateway 110 shown in FIG. 1. Of course, other power connections are possible. For example, a power line home run between each gateway 110 and power source 101 can be made (e.g., if a different circuit breaker is required for lighting fixtures 120 controlled by each gateway).

Each gateway 110 can be configured to receive digital control signals that originate from a system controller 150 or from another source. For the example implementation of FIG. 1, the system controller 150 can provide digital multiplex (DMX) control signals such as DMX signals (e.g., complying with the DMX512 standard). However, other digital signaling protocols can be used, such as Modbus, BACnet MS/TP, CANopen. The digital control signals can be received by a gateway 110 over a wireless or wired communication link 108 directly from the system controller 150 or from another gateway 110, as illustrated in FIG. 1. For example, each gateway can receive digital control signals at an input signal port 112. In some implementations, one or more of the gateways 110 can pass the digital control signal received at the input signal port 112 to an output signal port 114. The digital signal passed to the output signal port 114 may be altered by the gateway 110 (e.g., filtered, amplified, or otherwise cleaned up by signal repeating circuitry in the gateway 110) or unaltered by the gateway 110 (e.g., simply tapped off from the input signal port 112). However, in some implementations, a gateway 110 may not include an output signal port 114 and need not pass received digital signals to another gateway. Such gateways can be implemented in a star or hub network for a lighting system.

A received digital signal from the system controller 150 or other source can include multiple commands in some cases. For example, the received digital signal can include commands to set light intensity and color temperature differently for lighting fixtures 120 connected to one or more gateways 110. A first portion of the received digital signal may be addressed to a first gateway, and a second portion of the received digital signal may be addressed to a second gateway.

By sharing input AC power and passing digital control signals, as depicted in FIG. 1, the gateways 110 can be daisy-chained together such that independent control of many lighting fixtures 120 (up to 100 or more lighting fixtures in this example and over 100 in other implementations) can be obtained with only one home run power line 102 and one communication link 108 (such as an Ethernet cable or other communication line or a wireless link). In some cases, there can be from 2 to 100 lighting fixtures 120 (or any subrange within the range of 2 to 100 fixtures) on the AC power line 105 from each gateway 110 that are controlled individually, in groups, or as a whole block in unison by the gateway. The number of lighting fixtures 120 powered by a single power line 102 may be limited by the amperage rating of the circuit breaker delivering power to the fixtures. The AC power line 105 from a gateway 110 can extend up to 500 feet from the gateway 110 or even up to 1000 ft from the gateway in some cases. There can also be up to 32 or even up to 64 gateways 110 daisy-chained together in a commercial or residential facility, though there is no hard limit to 64 gateways in a facility. More can be used in some cases. Also, gateways 110 can be installed on additional power lines fed by the power source 101.

Each gateway 110 can further be configured to couple received digital control signals that originate from the system controller 150 or other source onto its power output port 116 that can connect to an AC power line 105 for providing AC power and digital control signals to compliant lighting fixtures 120 on the power line. That is, the gateway can couple a received digital control signal (or a version of the received digital control signal) onto the same AC power line 105 that provides power to the lighting fixtures 120. The digital control signals coupled onto the power output port 116 and connected AC power line 105 can include intensity and/or color temperature commands, for example, to set the intensity and color temperature of each compliant lighting fixture 120 powered by the AC power line 105. For controlled devices other than lighting fixtures 120, the digital control signals can include commands for fan speed and heater setting, for example.

In some cases, each gateway 110 can selectively couple only digital control signals onto its AC power line 105 that are addressed to lighting fixtures 120 powered by the gateway's AC power line 105. For example, the gateways 110 can include signal processing circuitry to route only those digital signals addressed to lighting fixtures 120 powered by the gateway's power line 105. In a less complicated implementation of the gateways 110, each gateway simply couples all received digital control signals onto its power output port 116 and connected AC power line 105, and each lighting fixture 120 can respond only to digital commands that are addressed to the particular lighting fixture. For gateways 110 that include signal processing circuitry, the gateways may or may not reformat and/or re-encode received digital signals when coupling signals onto the gateway's power output port 116.

Because the gateways 110 do not include phase-cut dimmers, they can be made relatively small in size. For example, a gateway 110 can fit within a single-gang or double-gang switch box or outlet box. In such cases, the gateway would be inconspicuous when installed in a building and could be used to retrofit existing installations to provide sophisticated lighting control. In some implementations, a gateway includes a user interface 115 which can allow for some control at the gateway (e.g., during installation of the gateway 110 and lighting fixtures 120). The user interface 115, described further below, can have manual buttons and/or switches and LED indicator lights, for example. The gateway's user interface 115 may be used to initiate running of at least one program by the gateway's local controller 455 (e.g., a test procedure on the gateway (e.g., issue intensity and/or color temperature commands to test the connected lighting fixtures 120), set up the gateway 110 and/or controlled lighting fixtures 120 (e.g., indicate that a lighting fixture has, or lighting fixtures have, been connected to the gateway; set default intensity and/or color temperature for the controlled lighting fixtures), or run a selected mode of operation of the connected lighting fixtures 120 (e.g., an energy-saving mode where one or more of the connected lighting fixtures turn off or to a low light level when a sensor of at least one lighting fixture detects no motion for a duration of time, a dusk-to-dawn mode where the lighting fixtures turn on at dusk, etc.). The mode of operation may be stored at the gateway 110 and/or at the lighting fixtures 120. The program executed by the local controller 455 can be stored locally in memory 209 at the gateway 110. In some cases, each gateway 110 may not have a manual user interface, and instead be controllable wirelessly through a configuration app running on a smartphone 180, for example, or output from another gateway 110 or system controller 150. The configuration app can provide a user interface on the smartphone 180 for the gateway 110. In one example, the gateway 110 can be packaged in a size that is approximately 4.25 inch by 3.5 inch by 2.25 inch or smaller. In some cases, the gateway can be packaged in a DIN multi-board box measuring about 4.25 inch by 3.5 inch by 2.25 inch and installed in an electrical automation enclosure with other equipment. For example, a gateway 110 can mount on a Deutsche Institut fur Normung (DIN) rail in an electrical cabinet, enclosure, or box.

As an example of space saving, a conventional phase-cut technology controller to control 16 zones of lights would require about 30 inches by 15 inches by 4 inches of cabinet space. A system controller 150 and gateway 110 solution of the implementations described herein (that use digital control signals) could occupy about 8 inches by 8 inches of cabinet rack space or less for controlling 16 zones of lighting fixtures. Additionally, the conventional phase-cut controller would provide only 16 independent controls for the 16 zones, whereas the system controller 150 and gateways 110 could provide independent control for each lighting fixture in the installation (e.g., up to 1600 lighting fixtures or more). If each zone had 100 lighting fixtures (consuming 15 watts at maximum output each), each zone would draw at most 12.5 amps which could be accommodated by a single 15-amp circuit breaker.

Digital control signals can be output by the system controller 150 and transmitted over at least one communication link 108 (wired or wirelessly) to a first gateway 110 in the lighting system 100. The control signals can be based on user input provided to the system controller 150. For example, a user can enter intensity and/or color temperature commands on keypads 140, manual knobs, or a touchscreen at, or communicatively coupled to, the system controller 150. The system controller can issue the appropriate digital control signals to the gateways 110 to adjust lighting intensity and/or color temperature at lighting fixtures 120 identified by the user and identified in the control signals. Other aspects of lighting that can be controlled are modes of operation (e.g., flashing to alert an emergency situation or other event, fading to off, ramping to on, color sweeping for entertaining displays, entering an energy saving mode when room occupancy is not detected, etc.). Such modes of operation can be commanded or orchestrated by the system controller 150. In some implementations, an application running on a smartphone 180 can provide a user interface for a user to interact with the system controller 150 and control lighting in the lighting system 100.

To control lighting fixtures 120 independently, each lighting fixture can have a unique identifier (e.g., a serial number, a character string based on the serial number, or other assigned identifier). The system controller 150 can output a control signal (e.g., a data packet) for an individual lighting fixture 120 that contains two or more pieces of information. A data packet to control a lighting fixture 120 can include, for example, (1) a unique identifier for the lighting fixture and one or more of the following action items: (2) an intensity level at which to operate, (3) a color temperature at which to operate, and (4) a mode of operation. A lighting fixture 120 that detects its identifier can act upon the action items in the data packet. Lighting fixtures 120 that do not detect their identifier can ignore the action items in the packet.

### 2. LED Lighting Fixtures

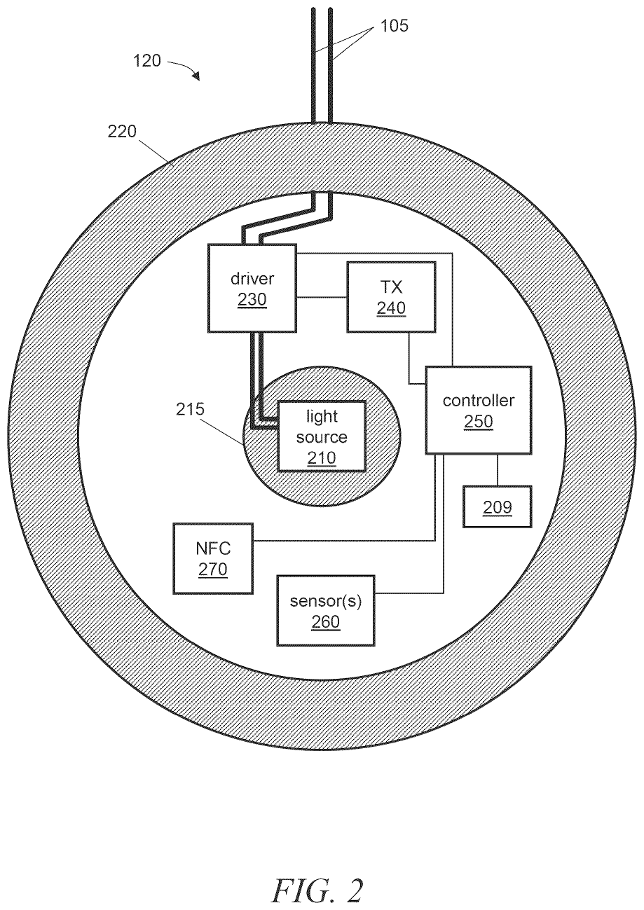

Lighting fixtures 120 can include, for example, LED downlights (which can be recessed), sconce lighting, suspended lights (such as chandeliers), floor lights, lamps, and linear form factor lighting (such as strip lighting, which may or may not be recessed). FIG. 2 depicts components of a compliant LED lighting fixture 120 that can be used in the lighting system of FIG. 1. A lighting fixture 120 can include an LED light source 210 which can be implemented as one or more chip-on-board (CoB) LED sources. The lighting fixture 120 can further include a driver 230 to provide power to the light source 210, a transceiver 240 (such as a power line carrier transceiver), and a local controller 250 (such as a microprocessor, microcontroller, field programmable gate array, application specific integrated circuit, logic circuitry, or some combination of these components). The lighting fixture 120 can further include an optical assembly for focusing and/or diffusing the light from the light source 210.

An LED source that is used in the light source 210 can be an assembly of one or more LEDs (e.g., packaged light emitting diodes) that emit different colors (optical frequencies) or a single color. An LED source that emits a single color can be one or more LEDs emitting at a same, narrow-band, emission (e.g., 630 nm peak emission with a 20 nm FWHM bandwidth about the peak). An LED source that emits different colors can be characterized by a color temperature (e.g., 3000 K). The LEDs and/or LED sources can be mounted on one or more printed circuit boards (PCBs), for example, which may or may not include a driver 230 for the LED sources. The LED source(s) can be thermally coupled to a heatsink 215 in the lighting fixture 120 to dissipate heat from the LED source(s).

In some cases, the light source 210 is a two-channel or three-channel device where an amount of power delivered to each channel controls emission output from two or three LED sources that emit at different colors. Each channel can be dedicated to an LED source that emits at a particular color. LED sources of different color outputs can be used to provide tunable color temperature and adjustable intensity. For example, the ratio of powers delivered to the LED sources can be varied to control the color temperature of emission from the light source 210.

The lighting fixture 120 can further include trim 220 and/or a casing in which to mount and house the light source 210, heatsink 215, and other components of the lighting fixture 120. The trim may serve as an aesthetic element and can also provide means, at least in part, to install the lighting fixture 120. There can be additional or alternative mounting hardware to mount the lighting fixture to the building structure. Examples of mounting hardware can include metal or plastic straps and screws, spring clips to attach to the housing, and/or mousetrap springs to secure the lighting fixture 120 directly to sheet rock, framing, or other building structure.

The LED driver 230 comprises circuitry to convert AC power to DC power and controllably deliver power to the LED source(s) of the light source 210. The LED driver 230 can receive power from the AC power line 105 that connects to a gateway 110 and can convert the received AC power to DC power. The LED driver 230 may include a switching power supply arranged in a buck topology with constant current regulation, though other power supply circuitry is possible. In some cases, the LED driver 230 can include independently-controlled driver circuits for each LED source of the light source 210 (e.g., to independently control power delivered to each LED source for controlling color temperature).

The transceiver 240 can be used to receive and transmit signals over the AC power line 105. The data rate over the power line can be as high as 250 kilobits per second, or higher in some cases. Each transceiver 240 can be configured to encode data using a carrier wave of a selected frequency in a range from 5 MHz to 30 MHz. In some cases, each gateway 110 can be assigned a different communication channel (comprising a different carrier frequency) to avoid signal interference between gateways and between corresponding lighting fixtures 120 controlled by the gateways 110.

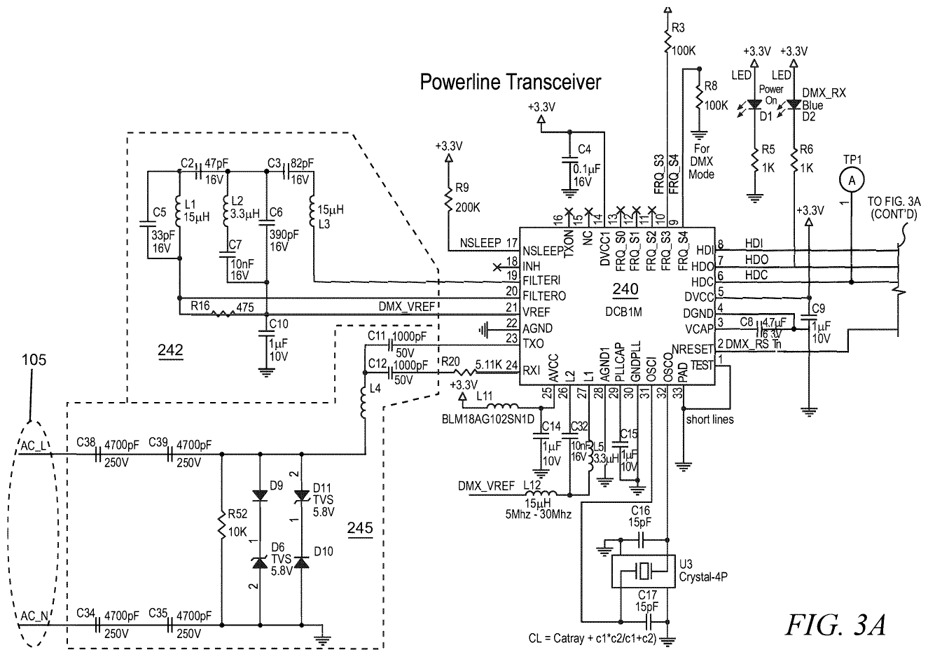

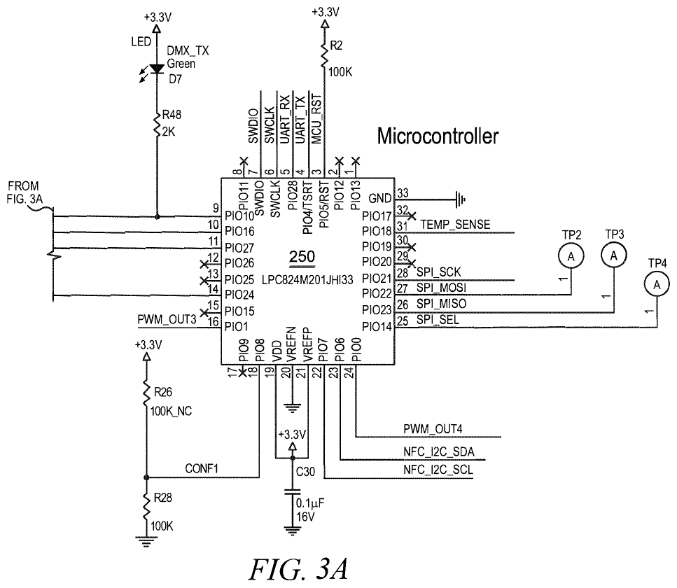

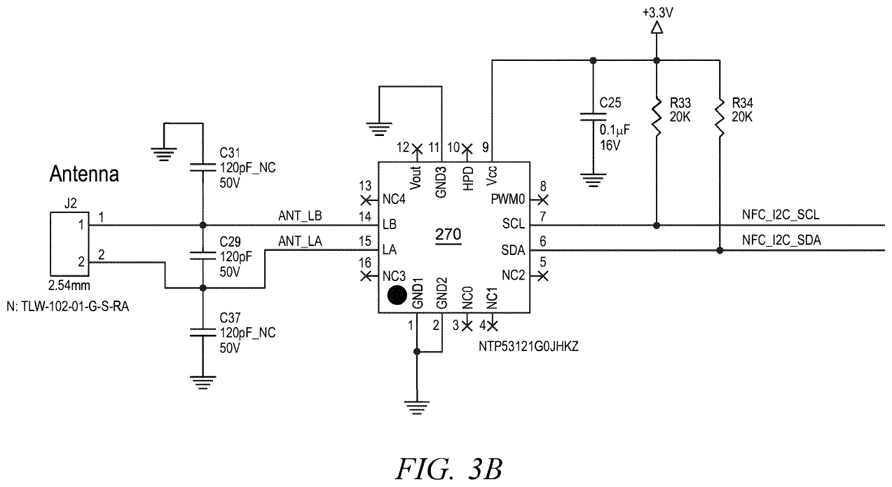

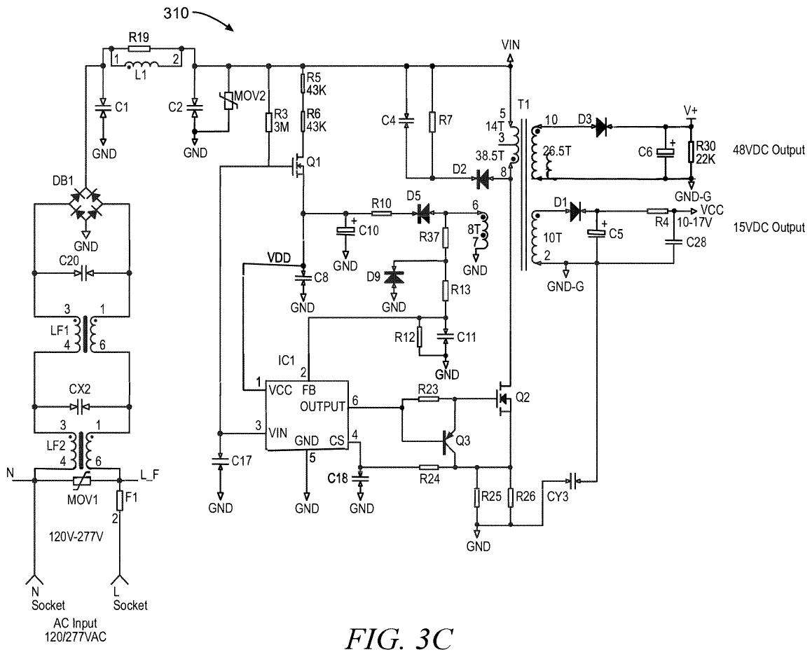

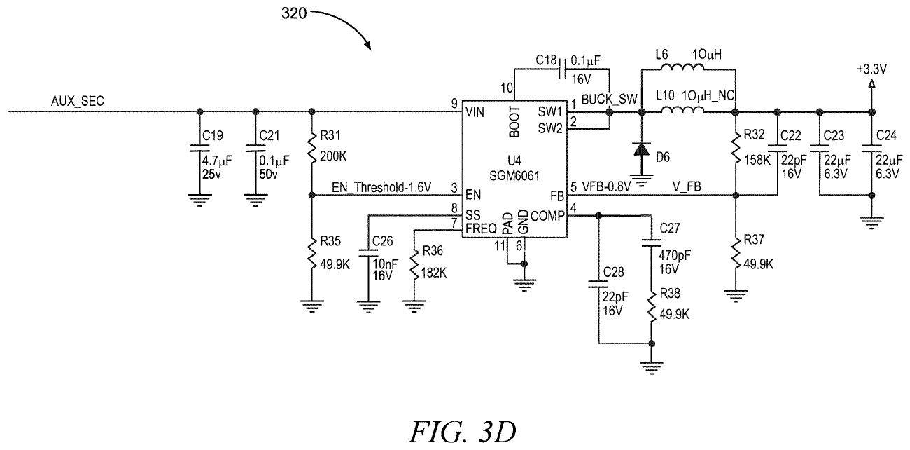

The transceiver 240 can be communicatively coupled to the local controller 250, as illustrated in FIG. 3A. The received digital signals can be transmitted to and processed by the local controller 250 (e.g., to control lighting intensity and/or color temperature output by the lighting fixture 120). Transmitted signals from the lighting fixture 120 can provide information about the lighting fixture 120 to the connected gateway 110 and/or system controller 150. Information about the lighting fixture 120 can include a unique identifier, as described above, information about the local environment from one or more sensors 260 mounted in the lighting fixture 120, operational status of the lighting fixture 120, and compatibility information (such as software version number that identifies a version of controlling software recognizable by the fixture's local controller 250). The transceiver 240 can include or be coupled to a signal coupling circuit 245 that is configured to couple digital data onto the AC power line 105 and couple digital data from the AC power line 105 (e.g., via an inductor and capacitor network coupled to the hot power line). In the example of FIG. 3A, the transceiver 240 can couple to the 120 V AC power line 105 via at least one inductor (L4) and one or more capacitors (e.g., capacitors C11 and C12). In some cases, the transceiver 240 can include signal filtering circuitry 242 as shown in FIG. 3A (e.g., to filter received signals). An example transceiver is the DCB1M power line transceiver available from Yamar Electronics of Tel Aviv, Israel.

The transceiver 240 can provide received signals to the local controller 250 for processing. For the example signal packet described above that is received from the gateway 110, the local controller 250 can determine whether the received signal is addressed to its lighting fixture 120 and act on the action items (e.g., intensity setting, color temperature, mode of operation) if the signal packet is addressed to the lighting fixture 120. If the signal packet is not addressed to the lighting fixture and is addressed to another lighting fixture 120 on the line, then the local controller 250 can ignore the action items.

The local controller 250 can be in communication with the LED driver 230 and control the LED driver to adjust the current flowing to each LED source of the light source 210. By adjusting current flow to one or more LED sources, the brightness and/or the color temperature of light emitted from the lighting fixture 120 can be controlled by the local controller 250 in response to information received via the transceiver 240. In this way, each lighting fixture 120 in a lighting system 100 can be controlled independently of other lighting fixtures in the lighting system 100.

In some cases, the local controller 250 can interface with the LED driver 230 using one or more PWM outputs to control current flow. For example, the duty cycle of a PWM waveform may set the output current for at least one channel that connects to at least one driver circuit within the LED driver 230. Multiple PWM channels can be used to control multiple driver circuits differently from each other.

The local controller 250 can also activate the transceiver 240 to communicate information to a gateway 110 connected to the AC power line 105 and/or to the system controller 150 via the AC power line 105 and connected gateway 110. The local controller 250 may communicate information such as a unique identifier of the lighting fixture 120, operating status of the lighting fixture, compatibility information of the lighting fixture, etc.

In some implementations, the lighting fixture 120 can also contain one or more sensors 260 to sense one or more aspects of an environment in which the lighting fixture 120 is located. Example sensors include, but are not limited to, a motion sensor, an ambient light sensor, a microphone, a temperature sensor, and an air-quality sensor. Data from the sensor(s) 260 can be received and processed by the local controller 250 and may be acted upon accordingly. For example, in response to detecting a low ambient light level and motion in the room, the local controller 250 can control the LED driver 230 to turn on the light source 210. The local controller 250 can also send information from, or derived from, the sensor(s) 260 to the transceiver 240 for transmission over the AC power line 105 to one or more gateways 110 and/or the system controller 150.

### 3. Local Controller and Transceiver

In further detail, FIG. 3A depicts a circuit schematic for an example implementation of a local controller 250 and transceiver 240 that can be used in a lighting fixture 120 of FIG. 2. The same local controller 250 and transceiver 240 can also be used in each gateway 110 of the lighting system 100 of FIG. 1. Although, a different local controller and/or transceiver can be used for the gateways in some implementations. Using the same local controllers and transceivers for gateways 110 and lighting fixtures 120 can reduce the number of different part types in the system.

The transceiver 240 is connected to the local controller 250 in the illustrated schematic. Among other things, the local controller 250 can send and receive data to and from the transceiver 240 via a serial UART connection over HDI and HDO signal lines. The local controller 250 can also provide multiple PWM outputs (PWM_OUT3, PWM_OUT4) as control signals to the LED driver 230. The local controller 250 can include multiple analog inputs (AN_IN1 through AN_IN4) to receive signals from various sensors 260 in the lighting fixture, for example. The local controller 250 further includes a plurality of digital input/output ports (indicated with “PIOn” designations in FIG. 3A, where n is a number). One example of the local controller 250 is the LPC824M201JHI33 microcontroller available from NXP Semiconductors of Eindhoven, Netherlands.

The local controller 250 can also be in communication with a near-field communication (NFC) chip 270, an example of which is illustrated in FIG. 3B. The NFC chip 270 can include EEPROM which allows configuration parameters of the lighting fixture 120 to be set remotely and wirelessly using an NFC-equipped device such as a mobile smartphone 180. Configuration parameters can be set during installation of the lighting fixture 120 by an installer, for example. An example NFC chip 270 is the NTP53121GOJHKZ chip available from NXP Semiconductors of Eindhoven, Netherlands.

### 4. Power Supplies

The lighting fixtures 120 can include at least one power supply. A first power supply can be an AC/DC supply that converts AC power to DC power. FIG. 3C is a schematic of a flyback power supply 310 that can be used to convert the AC power at 120 V to 48 V DC power (for the LED light source 210) and to 15 V and/or lower voltages for powering chips and other circuits in the lighting fixture 120. In some implementations, the transceiver 240 and local controller 250 can be powered with low voltage (e.g., 3.3 V). A switched-mode power supply can be included in the lighting fixture 120 to provide 3.3 V power from the 15 V output or 48 V output from the flyback power supply 310. An example circuit for a step down, 3.3 V power supply 320 is illustrated with the schematic of FIG. 3D. An example converter chip that can be used in the 3.3 V power supply 320 is the SGM6061 high-frequency buck converter chip available from SG Micro of Beijing, China. One or both of the flyback power supply 310 and 3.3 V power supply 320 can be included in the LED driver 230 of FIG. 2.

### 5. LED Driver Circuit

An example of an LED driver circuit 330 is shown in FIG. 3E. The LED driver 230 can include one or more LED driver circuits 330. There can be one LED driver circuit 330 for each LED source in the fixture's light source 210. The example LED driver circuit 330 comprises a constant current buck regulator circuit and an LED driver chip Hi7011 available from HiChips of Shenzhen, China. A PWM signal is applied to an input of the LED driver circuit 330 which buffers and outputs the PWM signal to the buck regulator. The duty cycle of the PWM signal determines the amount of current provided by the buck regulator to the LED source, which connects between the LED+ and LED-terminals shown in the drawing. The PWM signal input to the LED driver circuit 330 can come from the local controller 250 (e.g., from one of the PWM outputs PWM_OUT3, PWM_OUT4 shown in FIG. 3A. In this manner, the local controller 250 can control the intensity of emission from each LED source in the light source 210. By controlling the emission intensity from two or more LED sources that emit at different optical frequencies (different visible colors and/or different color temperatures), the local controller 250 can control the color temperature as well as intensity of light emitted from the lighting fixture 120.

In some implementations, a first LED source connected to a first LED driver circuit 330 can operate at a so-called “cool” color temperature emitting (e.g., with a color temperature in the range from 3000 K to 5000 K). A second LED source connected to a second LED driver circuit 330 can operate at a so-called “warm” color temperature (e.g., in the range from 1500 K to 2200 K). The local controller 250 can control the amount of current through each LED source by adjusting the PWM duty cycle applied to each LED driver circuit 330. The ratio of PWM waveform duty cycles (or ON times) applied to the two LED driver circuits 330 determines the relative amounts of current supplied to each LED source and therefore the relative intensities of the two LED sources and mix of their combined outputs. This mix of different color temperature emissions determines the resulting color temperature emitted by the light source 210 and lighting fixture 120. The duty cycle of each PWM waveform determines the total ON time of each LED source and therefore the total brightness of emission from the light source 210 and lighting fixture 120.

### 6. Gateway Communications

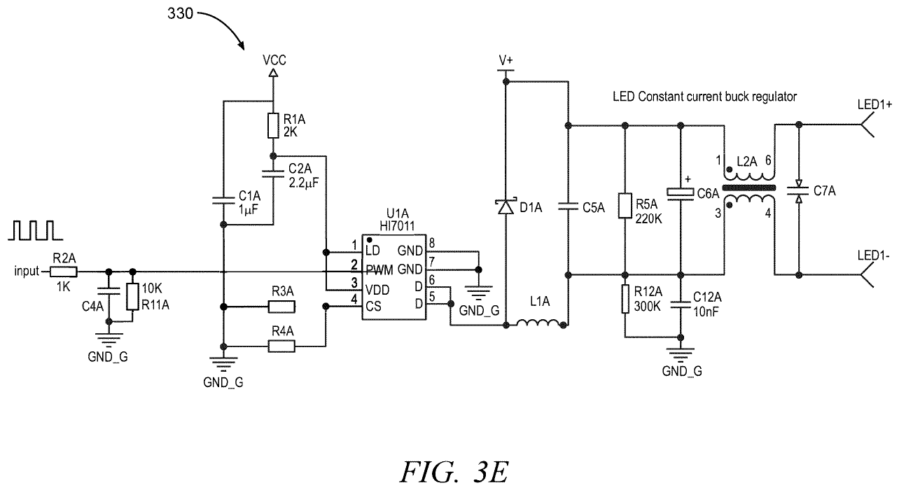

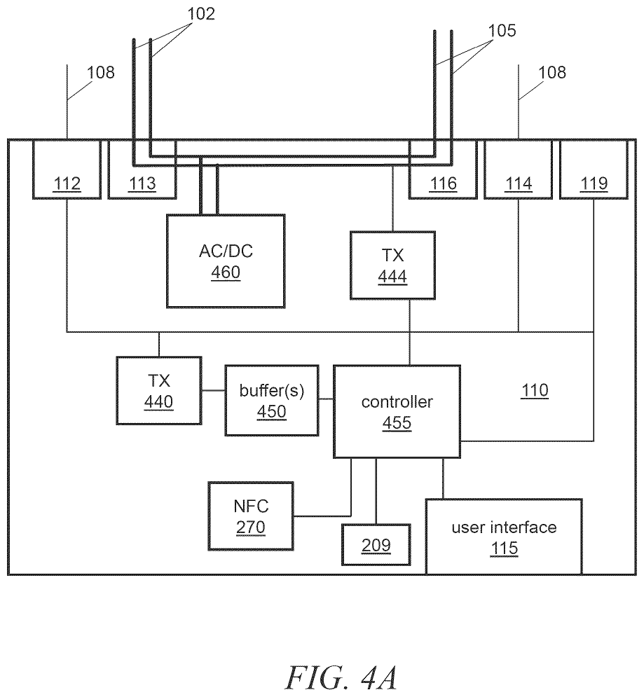

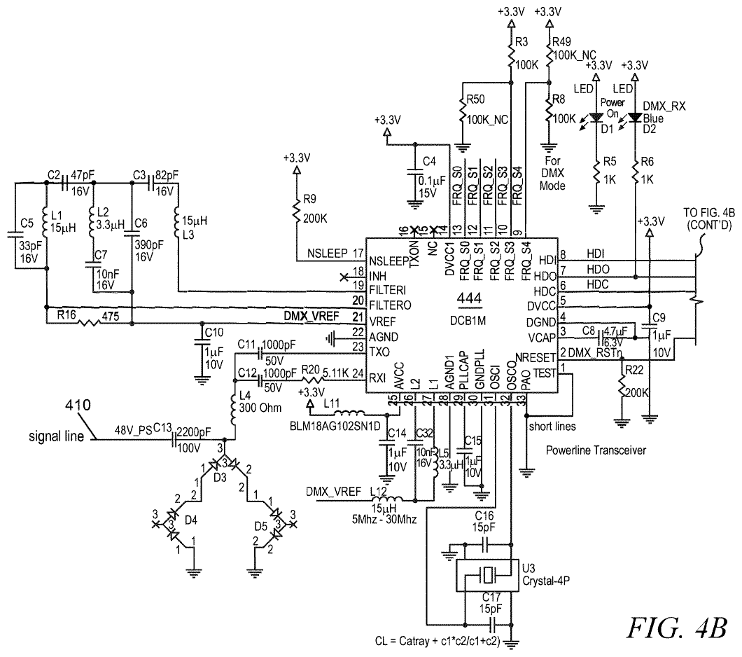

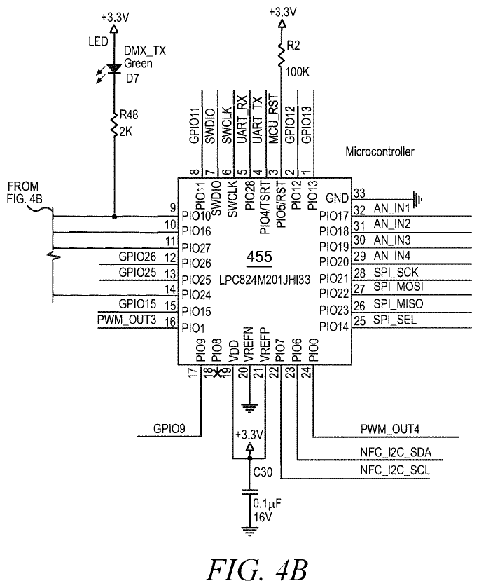

FIG. 4A is a block diagram depicting an example of a gateway 110 that can be used in the lighting system of FIG. 1. The gateway 110 comprises a local controller 455 and transceiver 444. As mentioned above, each gateway 110 can use the same make and model transceiver 240 (for the transceiver 444) and the same make and model local controller 250 (for the local controller 455) as is used in the lighting fixtures 120, though a different transceiver and/or a different local controller can be used in other implementations. The gateway 110 can include an additional transceiver 440 (which may be referred to as a “link transceiver”) to receive and transmit digital signals from and to the system controller 150 and other gateways 110 over the communication links 108 (which could be an RS-485 cable or compatible line or wireless link, for example). Signals communicated between the link transceiver 440 and local controller 455 can be buffered by one or more bus buffers 450.

The gateway 110 may further include an NFC transceiver 270 and antenna or other wireless transceiver for wireless communications with the gateway's local controller 455. In some implementations, wireless communication links between gateways 110 can be used instead of a wired communication link 108. Eliminating the wiring of wired communication links 108 can make installation of the gateways 110 easier, particularly for retrofit installations.

In some cases, the gateway 110 can include an auxiliary jack 119 for establishing a wired connection to communicate with the local controller 455 of the gateway. Communication through the auxiliary jack 119 can be established directly with the local controller 455 in some implementations, with or without signal buffering. For example, communications may be established through universal asynchronous receive/transmit (UART) pins on the local controller 455. In other implementations, communication through the auxiliary jack 119 can be established with the local controller 455 through the link transceiver 440.

The gateway 110 can further include an AC/DC power supply 460 which can convert AC voltage and power received at the power input port 113 to at least one DC voltage and power and output one or more DC voltages (e.g., 5 V and 3.3 V). The AC/DC power supply 460 can provide at least one DC voltage and power for circuits and chips within the gateway 110 (e.g., to the local controller 455 and transceivers 440, 444).

An example schematic for a portion of the gateway communication circuitry is shown in FIG. 4B. To issue communications from the local controller 455 at the gateway 110, the local controller 455 can activate the transceiver 444 to digitally encode signals onto a signal line 410. The signal line 410 couples to a gateway signal coupling circuit 470 that includes capacitors (e.g., C4, C5, C9, C10) to couple the digital signal from the signal line 410 to the gateway's power output port 116. (See FIG. 4C.) Digital signals can then be communicated to the lighting fixtures 120 on an AC power line 105 that connects to the gateway's power output port 116. Signals from the lighting fixtures 120 can be received over the AC power line 105, coupled back onto the signal line 410 by the gateway signal coupling circuit 470, and transmitted to the transceiver 444, which can transmit received signals to the local controller 455. Accordingly, each gateway 110 can have bidirectional communications with its connected lighting fixtures 120.

AC power received at the gateway's power input port 113 is filtered with a power line filter 430 comprising two inductors L1, L2 and a shunt capacitor C7 and passed to the power output port 116. At least one of the inductors L2 can block digital signals applied by the gateway 110 to the power output port 116 from propagating back to and from the power input port 113 (and onto the AC power line 102). Blocking the digital signal can comprise reducing the amplitude of the digital signal past the power line filter 430 to less than 10%, less than 5%, less than 1%, or even less than 0.1% in some cases. The digital signal can be applied to the AC hot line and AC neutral line, with the neutral line used as a reference level (e.g., ground) for the digital signal. Other circuit elements (e.g., active filtering) can be used for the power line filter 430 instead of, or in addition to, those shown in FIG. 4C. The filtering with the power line filter 430 can remove noise from the received AC power for each gateway 110 in a lighting system 100. The noise that is removed can occur from appliances and/or equipment in the facility (which may couple noise onto power lines running between gateways). Such noise, if not removed, would otherwise couple to the AC power line 105 running to the lighting fixtures 120 and could interfere with digital signal communications between the gateway 110 and its connected lighting fixtures 120.

The filtering by the power line filter 430 produces filtered AC power that can be output onto the AC power line 105. The inventor has recognized and appreciated that such appliance and equipment noise can interfere with digital signaling over the AC power line 105 and compromise performance of the lighting fixtures 120 and lighting system 100. The power line filtering thus improves signal communications between each gateway 110 and lighting fixtures 120 connected to the gateway's output AC power line 105, and thereby improves overall system performance compared to systems that broadcast signals over a facility's AC wiring.

Digital control signals from the system controller 150 can be received at the gateway's input signal port 112 (which can comprise a cable jack for a wired communication link or an antenna for a wireless communication link) and, in some cases, digital signals for the system controller 150 can be transmitted from the gateway's output signal port 114 (which may also comprise a cable jack for a wired communication link or an antenna for a wireless communication link). Communications to and from the system controller 150 (and to and from other gateways in the system) can be carried on communication links 108 that are separate from the AC power lines 102, so as to avoid the above-mentioned noise interference arising from appliances in the facility or home. In some cases, communications on a communication link 108 is bidirectional, so that a gateway 110 can receive signals from the system controller 150 at its input signal port 112 and also transmit signals to the system controller 150 from its input signal port 112. The gateway can further transmit and receive digital signals on its output signal port 114.

Communications to and from the system controller 150 can be transmitted and received at the gateway by the link transceiver 440, shown in the circuit schematic of FIG. 4D. The link transceiver 440 can be compatible with RS-485 signaling protocols, for example, or other signaling protocols. In the illustrated example, the second transceiver comprises the SN65HVD82DR RS-485 transceiver available from Texas Instruments of Dallas, Texas. Signals between the link transceiver 440 and the gateway's local controller 455 can be buffered with bus buffers 450 so that I/O pins at the local controller 455 can be used to send and receive signals to and from the link transceiver 440.

### 7. Gateway Interface and Configurations

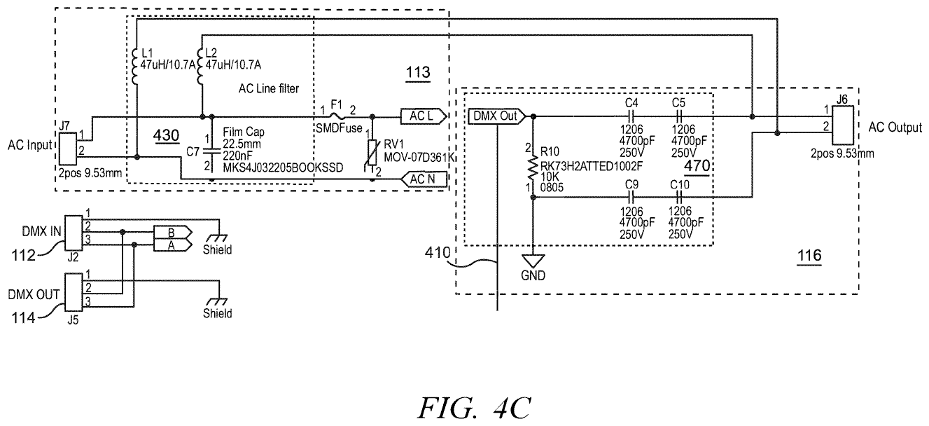

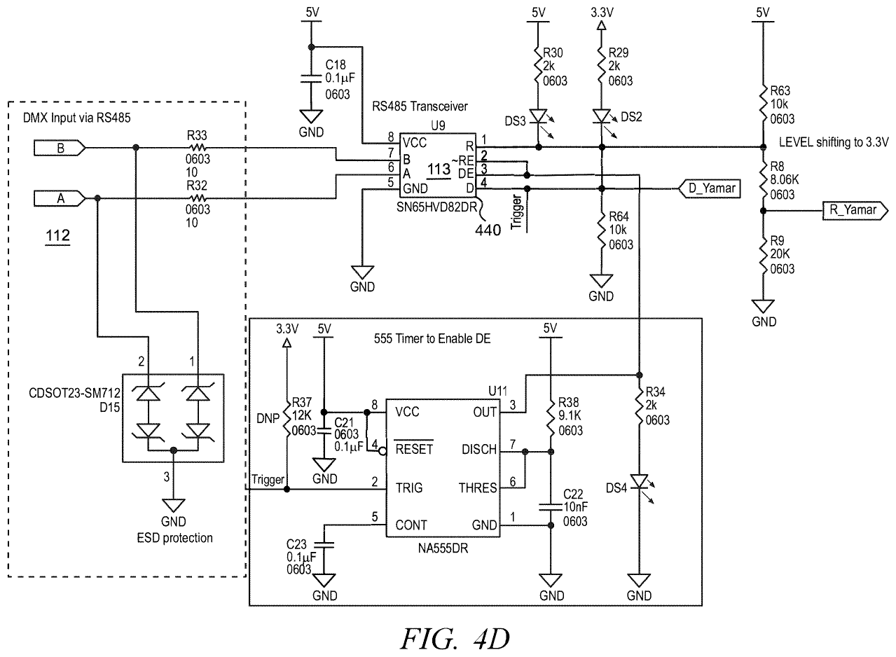

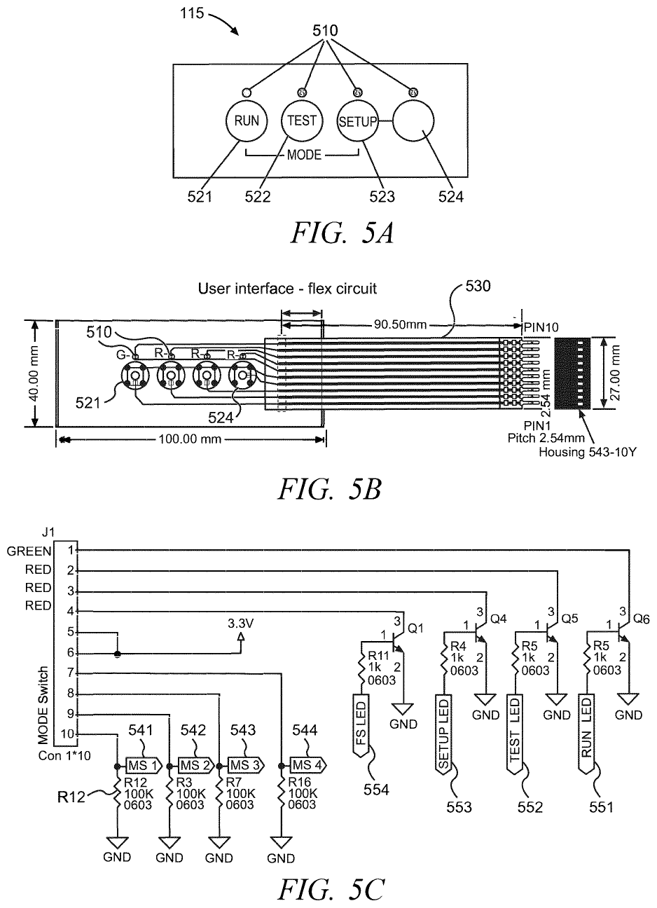

In some implementations, one or more of the gateways 110 includes a user interface 115. The user interface 115 can be low complexity and therefore low cost. An example user interface 115 is shown in FIG. 5A. Example circuitry for the user interface is shown in FIG. 5B and FIG. 5C. The user interface 115 can comprise four indicator LEDs 510 and four push-contact buttons 521, 522, 523, 524. The indicator LEDs 510 and push-contact buttons 521, 522, 523, 524 can be implemented using a thin, polymeric, flex circuit 530, depicted in FIG. 5B. The user interface 115 can be mounted on a front panel of the gateway 110, for example. Sense lines 541, 542, 543, 544 for the push-contact buttons and control lines 551, 552, 553, 554 for the indicator LEDs 510 can be communicatively coupled to eight I/O pins of the gateway's local controller 455. Pressing of any one of the push-contact buttons (e.g., button 522) can be sensed by the local controller as in increase or decrease in voltage on the corresponding sense line 542, depending on how bias is applied to the push-contact buttons. According to one example configuration, pushing a first push-contact button 521 can apply a voltage across a sense resistor R12, raising the voltage on the first sense line 541. Releasing the push-contact button 521 returns the voltage on the sense line to ground or zero volts. Any one of the indicator LEDs 510 can be turned on or off by driving the corresponding control line 551, 552, 553, 554 high or low, depending on how bias is applied to the indicator LEDs.

With only four push-contact buttons 521, 522, 523, 524 and four indicator LEDs 510, a large number of different actions can be taken by the gateway in response to user commands input at the gateway's user interface 115 using the buttons. Such commands can be entered during installation of the lighting fixtures 120. For example, once lighting fixtures 120 are installed and connected to a gateway 110, a test button 522 can be pressed to test the lighting fixtures. Depression of the test button 522 can be detected by the gateway's local controller 455 and cause the local controller 455 to disregard any commands from the system controller 150 and execute a test procedure stored locally at the gateway 110. The test procedure can comprise repeatedly flashing all lights on the gateway's AC power line 105. The installer can then walk through the facility to verify that all lighting fixtures 120 on the power line 105 are turning on and off. The test procedure can be one of several test procedures and can be indicated at the user interface 115 by the indicator LEDs 510 as a first combination of illuminated indicator LEDs. The installer may then select a different test procedure (e.g., by pressing the test button 522 and a scroll button 524) until the indicator LEDs 510 indicate a second test procedure (which may comprise sweeping the color temperature of all lighting fixtures 120 on the power line 105). The installer can then check that all lighting fixtures 120 are properly sweeping their color temperature. A setup button 523 may be used to temporarily disregard commands from the system controller 150 and set a default color temperature or default intensity for one or more lighting fixtures 120 on the AC power line 105. Again, the scroll button 524 can be used to scroll through different color temperatures that can be indicated by the indicator LEDs 510. With the four indicator LEDs, up to 16 different color temperatures can be indicated. Once the installer has tested and configured the lighting fixtures 120, the run button 521 can be pressed to place the gateway 110 in run mode, such that it can receive and act on control signals from the system controller 150.

The gateway's user interface 115 can be a significant aid to the installer or installers. Rather than testing and configuring lighting fixtures from a single system controller 150, the installer can test and configure the lighting fixtures 120 at or very near to the location where the lighting fixtures are deployed. The installer need not figure out how to access a newly installed zone of lighting fixtures from a single system controller 150. If multiple installers are working at the same facility, they need not all coordinate time to use a single system controller 150 to test their installed lighting fixtures 120. Instead, each installer can test a local lighting zone independently of the other zones and simultaneously while other zones are being installed and/or tested. Additionally, the newly installed lighting fixtures 120 need not even be connected to the system controller 150 to test signal communications over the gateway's AC power line 105. AC power to the gateway can be obtained from anywhere in the facility and testing of lighting fixtures 120 on the AC power line 105 can be carried out using the gateway 110 only. Further, troubleshooting of the lighting fixtures can be performed at each gateway 110 (via the user interface) to rule out or identify local problems, which can reduce service and repair time.

Additional configurations and operations of the gateways 110 are possible. In the system described above, each gateway 110 can couple digital data to the standard power line wires connected between the gateway 110 and its controlled lighting fixtures 120. The wiring used is conventional AC power wiring. To reduce the negative effects of other electrical appliances that may add noise coming in on the input power line and interfere with communication signals, a power line filter 430 can be used (before or within the gateway 110). Only the controlled fixtures 120 are connected to the output of the power line filter 430 preventing other equipment from degrading the communication between gateway 110 and fixtures 120.

This system configuration works well in a centralized wiring topology where all lighting fixtures 120 are wired back to a controlling gateway 110. However, many homes are built using a conventional wiring topology where power is fed from circuit breakers to various electrical junction boxes throughout the home. Each junction box can contain switches or dimmers that supply power to the connected fixture(s) for that box. However, the electrical feed from the circuit breaker to the junction box will often feed power to receptacles and other equipment along the same power line that runs to and from the junction box. Installing the previously described gateway in such a scenario can be difficult and, in some cases, may not be feasible with significant electrical rewiring.

To facilitate installation and upgrades of such wired houses (e.g., legacy wiring in a conventional house), the gateway 110 can be size to fit within a standard junction box that would otherwise house a switch or dimmer for controlled lighting fixtures on the lighting circuit from the junction box. For example, the gateway 110 is sized to fit within a single-gang junction box, which measures about 4 inches high, about 2 inches wide, and about 2 inches deep. In some cases, the gateway 110 is sized to fit within a double-gang junction box, measuring about 4 inches high, about 4 inches wide, and about 2 inches deep. The gateway 110 can receive an AC power input and provide an AC power output as described above for powering one or more lighting fixtures 120 installed on the controlled power line extending from the junction box. The AC input can be fed from and connect to the power source 101 (e.g., circuit breaker) via the existing wiring feeding the junction box. The gateway 110 can be configured to replace the switch or dimmer in the existing junction box.

In some implementations, the gateway can include a wireless transceiver (e.g., NFC transceiver 270) to receive signals from the system controller 150 or other device (e.g., smartphone, personal computer, tablet computer, handheld controller, wireless gateway, or Wi-Fi router, etc.). The gateway 110 can receive commands wirelessly and communicate to the connected light fixtures 120 by coupling data to the AC output wiring, as described herein. The power line filter 430 (comprising one or more inductors and one or more capacitors) can significantly attenuate noise from the AC input power line 102 and thereby significantly reduce or essentially prevent noise being output on the AC output power line 105. In some implementations, the power line filter 430 can significantly reduce or essentially prevent the digital signal coupled to the AC output power line 105 from coupling back onto the AC input power line 102.

The gateway 110 can provide a local user interface (wireless and or via push-buttons, switches, etc.) for the user to directly control the connected lighting fixtures 120 (e.g., to operate one or more of the lighting fixtures to produce a desired lighting characteristic such as intensity, color temperature, sweeping or modulating intensity, sweeping or modulating color temperature). According to some implementations, the user interface comprises switches or buttons that are operated by the user to recall lighting settings (sometimes referred to as “scenes”), each recalled scene triggering the controlled lighting fixtures to operate at a predefined intensity and color temperature. The scenes can be programmed into memory 209 of the gateway 110 and/or controlled lighting fixture(s) 120.

In some implementations, some gateways 110 may not have a user interface 115. Omitting the user interface and its circuitry can reduce cost of the gateway 110. Such gateways 110 without a user interface 115 can still be controlled in the lighting system 100. For example, the user interface 115 on a first gateway can be operated to control lighting fixtures 120 physically connected to a second gateway by transmitting a command wirelessly (e.g., addressed to the second gateway) from the first gateway to the second gateway. The second gateway receives the wireless signal and operates its connected lighting fixtures 120 in accordance with the transmitted command (e.g., to illuminate according to a recalled lighting scene).

### 8. Improving System Communications

The inventors have recognized and appreciated that the lighting system 100 of FIG. 1 can exhibit reflections and nulls at carrier frequencies used for encoding signals onto the AC power lines 105. The reflections can occur because conventional AC power lines 105 are generally not designed for impedance matching at the carrier frequencies used for signaling. For example, reflections can arise from ends of the AC power lines 105 that are not terminated into an impedance-matched load at the carrier frequency. These reflections can lead to nulls (regions of low or no signal strength) along the AC power line 105 where reflected waves interfere destructively with transmitted waves. Fixtures farther from the gateway 110 and closer to the end of the wire are more likely to exhibit poor communication as the signal levels may have attenuated significantly due to propagation losses and/or signal reflection. In regions at and near nulls the transmitted signal level can drop below the receiver's noise floor, preventing control data from being decoded at the lighting fixture 120. As a result, communication errors can arise between the gateway 110 and some lighting fixtures 120 on the AC power line 105. In some cases, the communication errors can result in momentary blinking of a lighting fixture 120 which is visually unappealing to a user. There are a number of ways to configure the lighting system 100 to mitigate or eliminate these communication errors.

### 8.1. Use of Different Carrier Frequencies and Communication Channels

The location of the nulls in signal strength along the AC power line 105 that extends from a gateway 110 is related to the carrier frequency used to transmit the signal and the length and layout of the AC power line 105. Changing the carrier frequency can change the location of nulls and correct signaling errors for some implementations of the lighting system 100. However, changing the carrier frequency and moving the nulls might correct communication errors for some lighting fixtures 120 but inadvertently lead to communication errors at other lighting fixtures 120 that become located at new nulls along the AC power line 105.

According to some implementations, multiple carrier frequencies can be used to transmit signals in the lighting system 100. For example, two or more carrier frequencies can be used to transmit control signals from the gateway 110 to its connected lighting fixtures 120 on the AC power line 105. Further, the lighting fixtures 120 on the AC power line 105 may use two or more carrier frequencies to transmit data to the gateway 110. As discussed further below, it should be appreciated that the carrier frequencies use to transmit control signals from the gateway 110 to its connected lighting fixtures 120 at a given time need not necessarily be the same carrier frequencies that the lighting fixtures use to transmit data to the gateway.

According to some implementations, the gateway 110 can be configured to sequentially transmit one or more control signals to its connected lighting fixtures 120 by stepping through different carrier frequencies, each carrier frequency defining a communication channel on which the one or more control signals are encoded. There can be from 1 to 20 or more carrier frequencies for the communication channels stored in memory 209 at the gateway and stored in memory 209 at the lighting fixtures 120 used in the lighting system. Carrier wave frequencies can be stored in the respective memories as part of a manufacturing process of the devices, during installation of the devices, and/or after installation of the devices. The frequency spacing between communication channels can be from 500 kHz to 2 MHz, for example, though smaller or larger channel spacings can be used. In some cases, a frequency spacing of approximately 1 MHz is used. With reference again to FIG. 4A, the controller 455 of the gateway 110 can reconfigure the transceiver 444 to step through the communication channels (e.g., by configuring the transceiver 444 to operate at the corresponding carrier wave frequencies), transmitting the same control signal(s) on each communication channel as it steps through the different channels. In this manner, all lighting fixtures 120 on the AC power line 105 may receive at least one transmitted control signal encoded on a carrier wave having sufficient strength at the lighting fixture so that the lighting fixture can decode the encoded control signal(s). Alternatively, the gateway 110 can include two or more power line transceivers 444 allowing it to transmit on multiple carrier frequencies simultaneously.

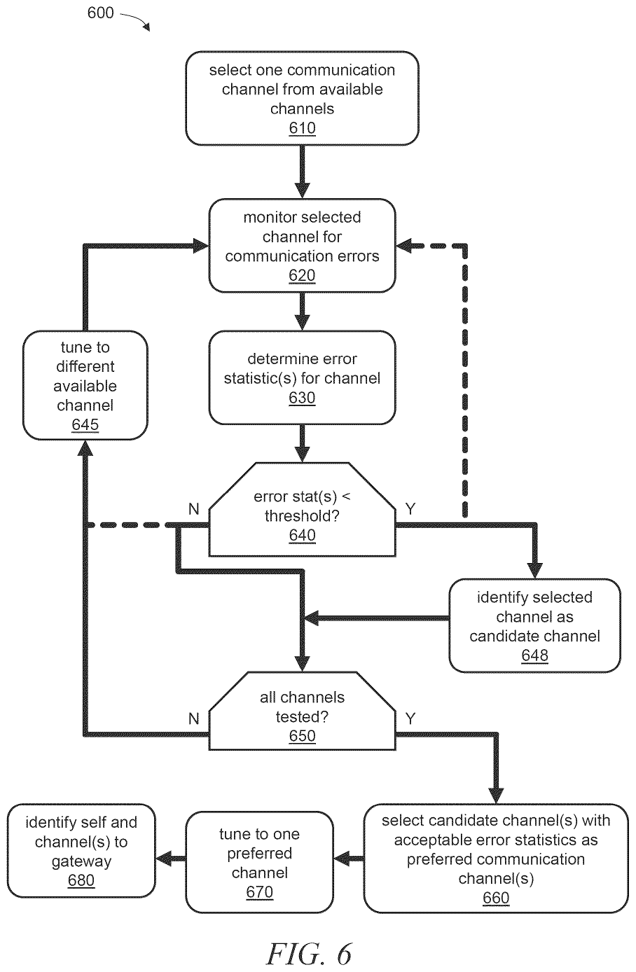

The transceivers 240 within the lighting fixtures 120 can, in some cases, only receive signals on a single communication channel (single carrier wave frequency) at any instance. Accordingly, the lighting fixtures 120 need to select a suitable communication channel for receiving and transmitting signals, which can be done by executing at least some of the acts of the method 600 depicted in the flow chart of FIG. 6. For example, the lighting fixture 120 can be programmed to select (step 610) one of the multiple available communication channels (and its carrier frequency) used by the gateway 110 as an initial communication channel. The lighting fixture 120 can then monitor (step 620) the selected channel for communication errors (such as packet errors) and determine (step 630) error statistics (such as packet error rate (PER), percent of corrupted packets received) for that communication channel. If the error statistic(s) for the channel is (are) below a threshold value (decision step 640), the lighting fixture 120 can remain on the communication channel and return (along the dashed line) to monitoring (step 620) the channel for communication errors. In some cases, if the error statistics exceed the threshold value (e.g. more than 0.5% corrupted packets and/or some other value), the lighting fixture 120 can automatically switch its receiver to tune (step 645) to a different communication channel of the multiple communication channels in response to the detected error statistics (proceeding along the dashed line in FIG. 6. The lighting fixture 120 can continue this process during operation to seek out a suitable communication channel and switch the communication channel one or more times if the error statistic(s) (e.g., PER) exceeds the threshold value. This approach of cycling through communication channels by the lighting fixture would mean that the gateway 110 needs to transmit control signals repeatedly on each communication channel long enough so that the lighting fixtures can cycle through all available communication channels used by the gateway. For example, if five communication channels are used by the gateway 110, then the gateway should repeat transmission of a command to the lighting fixtures on a first channel of the five channels for a period of time long enough that the controlled lighting fixtures 120 can cycle through all five channels to listen for the command before the gateway 110 moves to a second channel of the five channels.

In some implementations, the method 600 can be implemented by each lighting fixture 120 to determine a best or preferred communication channel for each lighting fixture. A preferred communication channel comprises a particular carrier wave frequency that exhibits acceptable packet error statistics (e.g., a channel exhibiting error statistics below the threshold, a channel exhibiting the lowest packet error statistics among tested channels). The carrier wave frequency can be stored in association with the identified preferred communication channel by the gateway 110 and or lighting fixture 120.

When determining a preferred communication channel, at decision step 640 in FIG. 6, if the detected error statistics for the channel is less than the threshold value, the lighting fixture 120 can identify (step 648) the current channel under test as a candidate communication channel. As part of this identifying step 648, the lighting fixture 120 may store the channel in memory along with its error statistic(s) for a later comparison. If the detected error statistics for the channel is not less than the threshold value, then the lighting fixture 120 can determine (decision step 650, proceeding along the solid line in FIG. 6) whether all available channels have been cycled through and tested. If all channels have not been tested, the lighting fixture 120 can tune (step 645) to a different communication channel of the available channels. The process of monitoring communication errors and tuning through communication channels can continue until all communication channels have been tested. When all channels have been tested, the lighting fixture 120 can select (step 660) one or more communication channels of the candidate channels with acceptable error statistics (such as packet error rate) as one or more preferred communication channels. The lighting fixture 120 can then tune (670) to a preferred communication channel and transmit to the gateway 110 an identifier for itself (e.g., a UID) along with identification of one or more preferred communication channels. Once preferred communication channels are established for the lighting fixtures 120, each lighting fixture can remain tuned to its preferred communication channel or one of its preferred communication channels. The gateway 110 can transmit and retransmit commands to the controlled lighting fixtures 120 using each carrier wave frequency at the gateway's transceiver 444 that corresponds to the available communication channels or using only the channels identified as preferred channels by the lighting fixtures. For example, if all controlled lighting fixtures 120 on the AC power line 105 can communicate using only two channels of the available communication channels, the gateway 110 can transmit a command on one of the two channels and retransmit the command on the second channel.

The cycling of lighting fixtures 120 through communication channels or selecting a preferred communication channel as described above in connection with FIG. 6 will work for the lighting system 100 provided the gateway 110 also cycles through the communication channels and repeatedly retransmits control signals on each channel in use by the system, or if the gateway 110 broadcasts on all communication channels simultaneously with two or more power line transceivers 444. This approach to system communications involves a significant amount of transmission redundancy that can consume communication bandwidth or add complexity to the gateway 110.

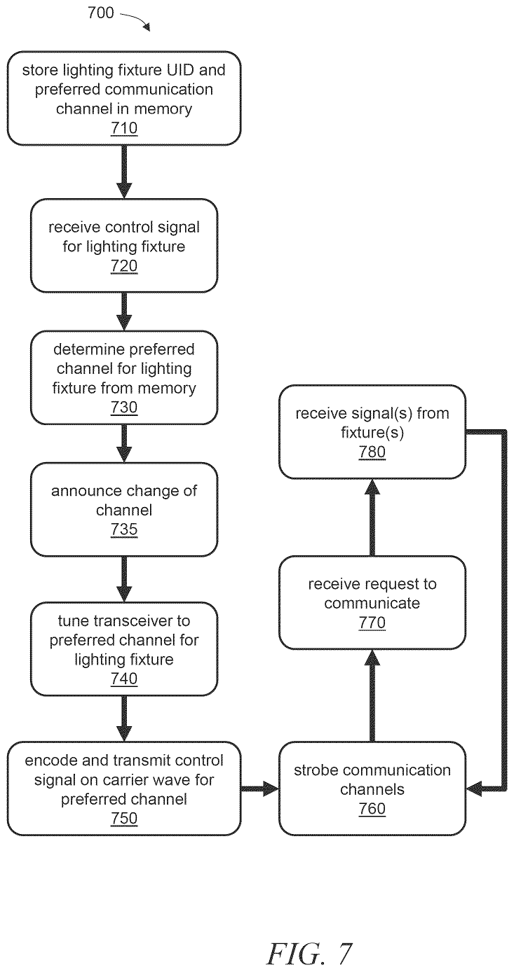

In other implementations, the lighting system 100 determines and uses different communication channels more efficiently, as outlined in the method 700 of FIG. 7. For example, during commissioning of the lighting system (or at some other interval, such as monthly, whenever the lighting system is altered, or whenever the lighting system is activated and AC power to the gateways are cycled off to on), the gateway 110 can be operated to execute a channel-search mode of operation. The channel-search mode can additionally, or alternatively, be initiated in other ways (e.g., by executing a stored program using the gateway's user interface 115 or a command from the system controller 150). In the channel-search mode, the gateway 110 can transmit a plurality of packets (e.g., 100 to 1000) on each communication channel while each lighting fixture 120 on an AC power line 105 controlled by the gateway 110 determines its preferred communication channel (e.g., the channel exhibiting the lowest packet error rate) as described above in connection with FIG. 6. When a lighting fixture 120 determines its preferred communication channel, the lighting fixture can further identify (step 680) itself and the communication channel to the gateway 110. In some implementations, a lighting fixture can identify more than one communication channel to the gateway 110 as a preferred communication channel. The gateway 110, in accordance with the method 700 of FIG. 7 can then store (step 710) in its memory 209 (e.g., in a look-up table) a unique identifier (UID) for each lighting fixture 120 connected on the AC power line 105 and one or more corresponding preferred communication channels for each lighting fixture 120. When the gateway 110 receives (step 720) a command to control a particular lighting fixture on the AC power line 105, it can access the memory 209 and determine (step 730) the preferred communication channel to use for the lighting fixture 120. The gateway 110 may or may not announce (step 735) on all communication channels that it is changing to the preferred communication channel. The gateway 110 can then tune (step 740) its transceiver 444 to the preferred communication channel for the targeted lighting fixture 120 and encode and transmit (step 750) the received control signal on a carrier wave used for the preferred communication channel for that lighting fixture. In this approach, the gateway 110 need not repeat the same control signal on all communication channels.

The gateway 110 may announce a change of channel when there are controlled lighting fixtures 120 that identify more than one preferred communication channel to the gateway. The gateway 110 may not announce a change of channel if a command is addressed to one or more lighting fixtures of the controlled lighting fixtures that are not able to receive commands on the current communication channel. Since the commands are not intended for reception by lighting fixtures on the current channel, it will make no difference to their operation if their communication channel is dropped for a period of time while the gateway 110 transmits commands to lighting fixtures on another channel. Further, in some instances, it may be preferable that the lighting fixtures on the current channel do not change channel to avoid their reception of commands not intended for them.

A constraint of this approach occurs when a lighting fixture 120 wants to communicate information (e.g., information from a sensor at the lighting fixture) to the gateway 110, which may not be communicating on the fixture's preferred communication channel at the time the information from the sensor is received. This constraint can be handled by queueing data at the lighting fixture 120 until the gateway 110 communicates another control signal or information to the lighting fixture 120. Once communication is established with the lighting fixture 120 by the gateway 110, the lighting fixture 120 can signal that it has information to transmit to the gateway 110 and subsequently transmit the information before the gateway 110 changes to another communication channel.

In some cases, waiting for the gateway 110 to send a control signal or information to a lighting fixture 120 may be too long based on the nature of the information from the sensor that the lighting fixture wishes to transmit to the gateway. In particular, data from a sensed condition at the lighting fixture 120, which may have been important in the moment the information was sensed, may become outdated or result in an action by the gateway 110 that is too late. For more rapid bidirectional communications between the gateway 110 and its controlled lighting fixtures 120, the gateway 110 can be configured to strobe (step 760) communication channels during idle times (times when the gateway is not issuing control signals). The strobing by the gateway 110 can comprise configuring its transceiver 444 to listen on each channel for a period of time (e.g., 10 ms in length to 100 ms in length) for at least one lighting fixture 120 to signal a request to communicate with the gateway 110. In some cases, the period of time can be about 20 ms. If such a request is received (step 770), the gateway 110 can remain tuned to the lighting fixture(s) preferred communication channel, over which the request to communicate was received, until the lighting fixture(s) 120 on that channel communicate the intended signal(s). After receiving the intended signal(s) (step 780), the gateway 110 can resume strobing (step 760) or take some other action.

The announcement (step 735) of a change in communication channel may be used by some of the lighting fixtures 120 to also change channel if the lighting fixtures have sufficiently low PER for the channel to which the gateway 110 is changing. The announcement can also alert lighting fixtures 120 not on the present channel that can communicate on the targeted channel that they will soon be able to transmit data to the gateway 110.

The carrier wave frequencies selected for communication channels may be manually set in some implementations. In some implementations, carrier wave frequencies used by the gateway's transceiver 444 can be programmed and selected by the local controller 455. For example, the local controller can issue commands to the transceiver 444 to select a carrier frequency and/or to step through two or more carrier frequencies. In general, lower frequencies in a range from approximately or exactly 5 MHz to approximately or exactly 8 MHz are attenuated less over the length of the AC power line 105 than higher frequencies and may be preferred for the lighting system 100. However, carrier wave frequencies up to 30 MHz or higher may be used in a lighting system 100. A gateway 110 may use from 1 to 20 different carrier wave frequencies (or any subrange therebetween) when communicating with its controlled lighting fixtures 120. In some implementations, 5 to 10 different carrier wave frequencies are sufficient for each gateway 110. The number of carrier wave frequencies used by a gateway 110 can depend, at least in part, on the length of the AC power line 105 used to connect to its controlled lighting fixtures 120 and layout of the lighting fixtures (e.g., number of circuit branches). The bandwidth of each channel can be from 50 kHz to 300 kHz. In some cases, a bandwidth of approximately 100 kHz is sufficient for each communication channel used by a gateway 110.

### 8.2. Use of Repeaters

The communication performance of the lighting system 100 can also be improved by employing repeaters in addition to, or instead of, communicating with different communication channels. While dedicated repeaters can be employed along the AC power line 105, adding repeater functionality to the lighting fixtures 120 simplifies the system hardware and installation process. For example, one or more lighting fixtures 120 on the AC power line 105 connected to the gateway 110 can be selected by the gateway to additionally operate as a repeater for that power line. When operating as a repeater, the lighting fixture can be configured to retransmit a control signal or information received from the gateway 110. The gateway may or may not designate the control signal or information for retransmission. For example, the lighting fixture tasked as a repeater may simply retransmit any data packets received from the gateway 110. Because of the repeater lighting fixture's different location compared to the gateway 110, nulls along the AC power line 105 that occur for certain distances from the gateway 110 may not be at the same location as nulls that occur for retransmissions from the lighting fixture 120 selected to operate as a repeater. Thus, lighting fixtures 120 that are in nulls for the gateway 110 may not be in nulls for the lighting fixture 120 acting as a repeater (also referred to more simply as “repeater”) and can receive sufficient signal strength to decode transmitted information. Also, lighting fixtures that are located large distances from the gateway 110, at which signal levels from the gateway 110 may have attenuated below acceptable levels due to propagation losses, can received an adequate signal level from a repeater that can be significantly closer to the lighting fixture than the gateway. In some implementations, use of repeater functionality may not require the use of multiple communication channels.

According to some implementations, multiple repeaters (whether implemented as stand-alone repeaters or selected lighting fixtures 120) can be employed within the lighting system 100 to ensure control signals are communicated reliably to all lighting fixtures 120 on the AC power line 105. Repeaters can also boost signal levels as the distance from the gateway 110 increases.

To avoid communication collisions within the lighting system 100 with multiple devices transmitting, the gateway 110 can coordinate operation of the repeaters on the AC power line 105, and may further coordinate signaling operations with other gateways 110 in the system. For example, the gateway 110 sends a “retransmit” message directed to a single, identified repeater on its AC power line 105 that instructs the repeater to retransmit a control message or other information transmitted by the gateway 110. The control message may be sent immediately before, after, or with the retransmit message. The gateway 110 can send such retransmit messages to multiple repeaters (and/or other gateways 110) in sequence, providing sufficient delay between each request for the repeater to retransmit the control message.

Alternatively, repeaters may employ a time slot mechanism where each repeater is configured to retransmit a received message from the gateway 110 in an assigned time slot. There can be a plurality of time slots (assigned to the repeaters) that extend one after the other following each message transmitted by the gateway 110. There can be two, three, four, eight, or more timeslots that are assigned to repeaters on the AC power line 105. Each repeater can be assigned a different and unique timeslot. After receiving a message from the gateway 110, the repeater waits for its timeslot to come up and then retransmits the received message during the assigned time slot. In instances where a first repeater is an intermediary between the gateway 110 and a second repeater on the AC power line 105 (e.g., the second repeater can only communicate with the gateway 110 through the first repeater), the first repeater can be assigned a time slot that occurs before the time slot assigned to the second repeater.

For repeater retransmissions in the lighting system 100, the gateway 110 should implement sufficient idle time (a period of no transmissions from the gateway 110) so that the repeaters can retransmit signals without having signals from the repeaters and gateway 110 collide. In a typical DMX based lighting control system, the packets may be transmitted at a high refresh rate, typically 40 times per second or every 25 ms. Each control packet may consist of the full 512 control slots employed in DMX512 control protocol, taking approximately 20 ms to transmit. If the gateway were to retransmit every DMX packet received, there would be only 5 ms of idle time which would be insufficient bandwidth for even one repeater to retransmit a received signal. To increase available bandwidth for retransmission of signals, the gateway 110 can limit its transmission refresh rate by down-sampling the incoming DMX data or buffering a received digital signal for a period of time before transmitting a control signal to the connected lighting fixtures 120. In either approach, the gateway 110 transmits control signals at a refresh rate lower than the typical DMX rate of 40 Hz. For example, transmitting control messages at a rate of 10 Hz could be sufficient for the vast majority of lighting control applications. The additional bandwidth recovered (75 ms out of 100 ms) can be used for retransmission of signals by the repeaters. The gateway 110 can choose to have all repeaters repeat its transmissions in sequence before sending another transmission or can interleave its own control messages between the repeaters' retransmitted messages.

Repeaters can also be used to notify lighting fixtures 120 on the AC power line 105 of channel change messages issued by the gateway 110 if the lighting system 100 is using multiple communication channels. When repeaters are being used in the lighting system, multiple communication channels may or may not be used in the system. Upon hearing the initial channel change message from the gateway, a repeater can reconfigure its power line transceiver 240 to use the newly assigned communication channel and can transmit a signal for lighting fixtures 120 communicatively coupled to the repeater to reconfigure their power line transceivers 240. Once the gateway 110 has completed its channel change, it may then send messages to each of the repeaters on the new communication channel, which in turn can retransmit the received messages to lighting fixtures 120 that are and/or become communicatively coupled to the repeater on the new communication channel. In some implementations, the gateway 110 can instruct each targeted repeater to cycle through all selectable communication channels, retransmitting the channel change message (e.g., to tune all lighting fixtures 120 to a same communication channel), before resuming operation on the assigned communication channel.

### 8.3. Selection of Repeaters

At least one lighting fixture 120 that is selected for repeater functionality should be one that has a high probability of receiving messages from the gateway 110 without error. Typically, lighting fixtures 120 closer to the gateway 110 (e.g., in the first one-third of the AC power line 105) and not located at a null will have the highest signal level. However, it can be more advantageous to have repeaters located close to the end of the AC power line 105 (e.g., the last one-third of the power line) such that the retransmitted signal will be well received by devices at the extremity of the power line. In some cases, selecting a lighting fixture 120, or fixtures) for repeater functionality or positioning a dedicated, stand-alone repeater near the middle of the AC power line (e.g., within the middle third of the power line) can provide adequate communications to all lighting fixtures 120 on the AC power line 105 (e.g., a PER below the threshold value for acceptable communications).

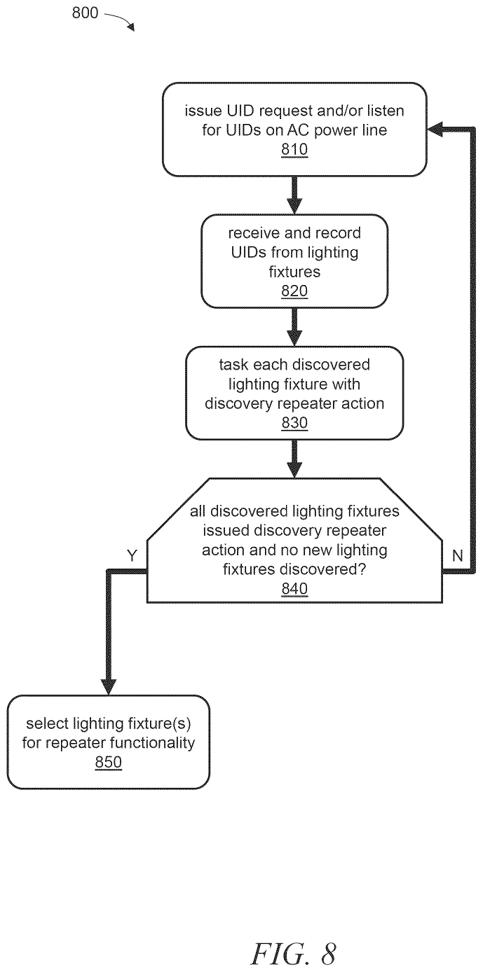

In some cases, repeater locations can be selected manually by an installer during installation and/or commissioning of the lighting system 100 based on the wiring layout (e.g., based on distance from the gateway) and/or system performance when activated (e.g., based on location(s) of non-communicative, non-responding lighting fixtures as installed). In the latter case, an installer can task a responsive lighting fixture with repeater functionality that is located adjacent to one or more non-responsive lighting fixtures along the AC power line 105. In other cases, the lighting system 100 can be configured to assign repeaters automatically without any manual repeater assignments, as next described in connection with the method 800 of FIG. 8.

Upon initial setup, the gateway 110 can execute an initial discovery process to discover at least a portion of the lighting fixtures 120 physically connected on the AC power line 105. For example, the gateway 110 can issue (step 810) a request over the AC power line 105 for lighting fixtures 120 to respond with their unique identifier (UID), which could be a portion of their serial number or other identifier, for example. In other cases, the controlled lighting fixtures 120 can be configured to transmit their UIDs during installment or a gateway configuration process which could be run at any time (e.g., when cycling AC power to the gateway 110 and connected lighting fixtures 120 as described elsewhere herein, when the lighting system is being services, when instructed remotely through a wireless interface to the lighting fixtures 120). In such cases, all lighting fixtures 120 can transmit their UIDs in sequence. The sequence may be a time-slotted sequence where the fixture's time slot is based on its UID. In some cases, the discovery process utilizes a binary search of device serial numbers or the UIDs.

The gateway 110 can then listen for, receive, and record (step 820) a list of all the connected devices' UIDs for those lighting fixtures 120 that respond and/or transmit their UIDs. Because some of the lighting fixtures 120 on the power line may be at a null with respect to the gateway 110 or at a distance from the gateway 110 where signals between the gateway and such fixtures attenuate to levels such that the PER becomes too high, these devices may not be detected by the gateway 110. Such “hidden” lighting fixtures 120 can go undiscovered in either of the two UID transmit processes described above.

To discover more lighting fixtures 120 on the AC power line 105 (e.g., the “hidden” lighting fixtures), the gateway 110 can task (step 830), in sequence, each initially-discovered lighting fixture 120 with a “discovery repeater action.” The discovery repeater action for each tasked lighting fixture 120 comprises at least two parts: (a) listen for and receive a transmission of UIDs from one or more lighting fixtures, and (b) transmit the received UIDs to the gateway 110. UIDs received by the tasked lighting fixtures may not have been detected by the gateway 110 (e.g., due to poor signal quality). The discovery repeater action can further comprise a third part (c) retransmit the initial UID request from the gateway 110, which would occur before parts (a) and (b) if the discovery process involves the initial request for UID sent from the gateway 110 rather than the lighting fixtures automatically transmitting their UIDs on initial setup. By tasking each discovered lighting fixture 120 with the discovery repeater action, and by tasking newly discovered lighting fixtures detected in response to each discovery repeater action with a discovery repeater action, all lighting fixtures 120 on the AC power line 105 can be discovered and recorded by the gateway 110. The gateway 110 can determine (decision step 840) whether all discovered lighting fixtures have issued a discovery repeater action and no new lighting fixtures have been discovered. If these two conditions are satisfied, then the gateway 110 can proceed to selecting (step 850) one or more lighting fixtures for executing repeater functionality (e.g., based on PER data). If there are newly-discovered lighting fixtures 120, then the method can return to issuing (step 810) a UID request or listening for UIDs (by at least the newly-discovered lighting fixture(s)).

In some implementations, the gateway 110 can base its selection (step 850) of lighting fixture(s) for repeater functionality, at least in part, on outcomes of the discovery repeater actions executed by each discovered lighting fixture 120. For example, the lighting fixture 120 that executes the discovery repeater action and returns the largest number of newly discovered lighting fixtures can be selected as a repeater to execute repeater functionality for the lighting system 100. Alternatively, or additionally, the gateway 110 may select, for added functionality as a repeater, the fewest number of lighting fixtures 120 that executed the discovery repeater action which results in discovery (or communicative coupling to the gateway 110) of all lighting fixtures 120 on the AC power line 105.

Once the discovery process is complete, the gateway 110 can instruct all lighting fixtures to turn on and/or change to a particular color temperature. This action can aid an installer to visually inspect each fixture and determine whether all lighting fixtures 120 are communicatively coupled to the gateway 110. If a lighting fixture is not communicatively coupled to the gateway 110, further action can be taken (e.g., re-running the initial setup, changing the lighting fixture, changing the length of an AC power line 105 connecting to the lighting fixture).

When all lighting fixtures 120 are communicatively coupled to the gateway 110, the gateway 110 can run a communication packet test by instructing the lighting fixtures 120 to reset their communication error statistics and begin logging communication error results. The gateway 110 can then transmit a number of test packets (e.g., between 100 and 1000, or even more in some cases) to the lighting fixtures 120. After transmission of the packets, the gateway 110 can request communication error statistics from each lighting fixture 120 using the list of UIDs previously discovered. Each lighting fixture 120 can report back the error statistics (e.g., the PER) in response to the request. Based upon the results of the error statistics, the gateway 110 may or may not reassign repeater functionality among the lighting fixtures 120. For example, if the PER is close to or exceeds an acceptable threshold value for one or more lighting fixtures 120, the gateway 110 may add repeater functionality to a lighting fixture 120 near the one or more lighting fixtures and/or move the location of a previously assigned repeater by cancelling repeater functionality for one lighting fixture and assigning repeater functionality to a nearby lighting fixture.

In some implementations, the selection and assignment of repeaters can be based, at least in part, upon transmitted signal power levels. In this approach, the gateway 110 can repeat the discovery process utilizing two or more different transmit power levels (e.g., high—approximately 100% of full transmission power, medium-approximately 50% of full transmission power, and low-approximately 25% of full transmission power) and instruct any assigned repeaters to also use the same two or more different power levels. The process may start with the highest transmit power level and then step down the transmit power level for each successive run of the repeated discovery process, though any order of the different transmit power levels can be used.

At medium power levels, some of the lighting fixtures 120 may lose communicative coupling with the gateway 110 and any assigned repeaters. At low power levels, more of the lighting fixtures 120 may lose communicative coupling with the gateway 110 and any assigned repeaters. Based on the results, the gateway 110 can categorize each fixture as “close,” “medium,” or “far,” though other designations can be used (e.g., “strong,” “medium,” “weak;” “cat1,” “cat2,” “cat3,” etc.) since received signal strength does not necessarily depend on distance from the gateway 110. Lighting fixtures 120 classified into the first category (e.g., cat1) can be those lighting fixtures that have adequate PER at all power levels. Lighting fixtures 120 classified into the second category (e.g., cat2) can be those lighting fixtures that have adequate PER at high and medium power levels but not at low power levels. Lighting fixtures 120 classified into the third category (e.g., cat3) can be those lighting fixtures that have adequate PER only at high power levels or fail to achieve adequate PER for any power level. The gateway 110 can then select lighting fixtures 120 for repeater functionality from among fixtures classified into the second and/or third category. The selection could be at random from within these two groups or may be done more judiciously using results of the discovery process in which discovery repeater actions are executed, as described above.

In some cases, selection (step 850) of repeaters by the gateway 110 can be based, at least in part, on receiver signal strength indication (RSSI). In this approach, the lighting fixtures 120 record and report back the analog RSSI measured when packets from the gateway 110 are being received by the lighting fixture 120. The analog RSSI can provide better granularity in classifying the signal strength at each of the lighting fixtures 120 on the AC power line 105. In this approach, each lighting fixture 120 includes hardware to measure RSSI, which can add complexity and cost to each lighting fixture 120.

To avoid added complexity and cost to the lighting fixtures 120, the RSSI can be measured at the gateway instead of the lighting fixtures 120. For example, the gateway 110 can include hardware to measure RSSI while the lighting fixtures 120 transmit packets to the gateway 110 (e.g., in response to a request from the gateway 110). By reciprocity, the RSSI measured at the gateway 110 when a lighting fixture 120 transmits a packet to the gateway can be essentially equivalent to the RSSI the lighting fixture 120 would measure when packets are transmitted from the gateway 110 to the lighting fixture 120. In this way a single higher complexity receiver to measure RSSI may be employed in the gateway 110 only without burdening each lighting fixture 120 to measure RSSI and transmit results.

Once repeaters have been selected, the gateway 110 can identify the repeaters to the installer or user, which can be beneficial for troubleshooting and reassignment purposes. Upon entering a setup mode on the gateway 110 or in response to a received instruction to identify repeaters, the gateway 110 can command the lighting fixtures 120 tasked with repeater functionality to identify themselves by flashing, setting color to a unique level and/or other means easily identifiable to the installer. In some implementations, the local setup mode at the gateway 110 can provide user-input options for the installer or user to reassign repeaters manually or via a random selection process.

### 8.4. Packet Error Protection

Traditional DMX512 network protocol does not employ any form of packet checksum or validation for detection of errors during signal transmissions. Conventional DMX512 relies upon the low bit error rate on a well installed RS485 network and the low severity of a bit error. Since the packets are refreshed at approximately 40 Hz, a small error may not be noticeable in traditional DMX applications.

When implementing power line communications, the risk of packet errors increases and the noticeability of an error in packet transmissions is higher for lighting systems as the errant command may result in lights turning on or off for a period of time noticeable to the occupants (e.g., a blink in lighting).

To mitigate effects of packet errors in communication between the gateway and its controlled lighting fixtures 120, the gateway 110 can add a checksum value to the end of each transmitted packet. The gateway 110 can further add, additionally or alternatively, header information in a transmission (such as packet length and/or number of packets). The lighting fixtures 120 can be programmed to evaluate the checksum and/or header information to determine whether transmitted packet(s) are received without error. The lighting fixtures 120 can be further programmed to disregard packets with errors.

### 8.5. Configuring Local Networks

Some installations may require multiple gateways 110, such that there exists the chance of crosstalk in communications when gateways 110 are operating on the same carrier channels and wires are run in close proximity. With crosstalk, it is possible that the complete packet including checksum is received without error (by an unintended lighting fixture 120 controlled by another gateway 110) causing some lighting fixtures 120 to be controlled by an incorrect gateway resulting in improper behavior of the lighting system 100. The effects of crosstalk on communications between a gateway 110 and its controlled lighting fixtures 120 can be mitigated or eliminated by partitioning the lighting system 100 into local networks 162, 164 referring to FIG. 1. In a local network, a network identification (e.g., an identifying string of characters) can be added by the gateway 110 to a control message intended for one or more lighting fixtures 120 controlled by the gateway. For example, the network ID can be included within the header of the control message or appended to a control message. Lighting fixtures 120 in a local network 162 can be programmed by the gateway to respond to only control messages containing the network ID associated with their controlling gateway 110 (the gateway immediately connected to the output power line 105 feeding the lighting fixtures 120 in the local network 162). The lighting fixtures 120 can be programmed to disregard control messages not containing the network ID associated with their controlling gateway 110. During and/or after installment of the lighting fixtures 120, the gateway 110 can send the network ID to its controlled lighting fixtures.

The gateway 110 can be configured to select a local network identification based on the gateway's serial number (for example) which is typically a 32-bit unique identifier (UID), though other methods of selecting a network ID are possible (e.g., random or sequential number assignment). In some implementations, an installer can assign network IDs to the gateways 110 of the local networks. Preferably, each local network within a lighting system 100 has a unique network ID.

During operation of the lighting system 100, the gateway 110 of a local network 164 can transmit control messages containing the network ID on the output power line 105, as well as a checksum to validate the packet integrity. The lighting fixtures 120 are configured to only process packets from their controlling gateway (packets containing the appropriate network ID). Any packets received with a different network ID (associated with a different gateway 110) are assumed to be cross talk and are ignored and/or discarded by the lighting fixture 120.

Configuring lighting fixtures 120 with a network ID can be done in a semi-automated way. In one approach, power on the AC output power line 105 for a local network 162 controlled by a gateway 110 is cycled off to on a predetermined number of times within a time period. The cycling of power can be done, for example, by tripping a circuit breaker at the power source 101. Such power cycling can also cycle power at the gateway 110. As part of a power up and network configuration routine, the gateway 110 can be programmed to transmit a “network join” messages which includes the network ID of the gateway 110. The lighting fixtures 120 can be programmed to listen for the network join message following the power cycling. Any lighting fixtures 120 that have been power cycled within a predetermined period of time (e.g., within the last 5 sec) will process the network join message(s) to detect a network ID and store the network ID for subsequent signal processing purposes (e.g., to discriminate against crosstalk signals). In some cases, a lighting fixture 120 can be programed to receive a predetermined number (e.g., 5, 7, 10, 13, 20) of the network join messages successfully before storing the network ID. The gateway 110 can be programmed to transmit the network join message for a period of time after power cycling to allow sufficient time for the connected lighting fixtures 120 to boot up, process the network join messages and set their network IDs. The complete process may take less than 15 seconds after which the gateway 110 resumes normal operation, transmitting control messages that include a network ID.

To avoid system-wide network configuration after a system-wide power failure, the number of power cycles to initiate network configuration actions can be from 2 to 10 or more within a predetermined time. For example, four power cycles occurring within 8 seconds may be used to initiate network configuration of a local network 162.

Local network configuration can be done in other ways. For example, DIP switches can be used on the gateway 110 and controlled lighting fixtures 120 to set a network ID at installation time. Alternatively, a network ID can be set wirelessly at the gateway 110 and lighting fixture 120 during installation using NFC transceivers 270.

### 9. Commissioning the Lighting System

Installation of lighting fixtures 120 can comprise commissioning the lighting system 100 before it is approved for user operation. Commissioning of the lighting system 100 can comprise identifying all gateways 110 present in the system and identifying all lighting fixtures 120 in the system. Commissioning of the lighting system 100 can further comprise defining lighting zones within the system. Commissioning of the lighting system 100 may also comprise defining lighting operations that run automatically at predefined times and/or in response to sensed environmental conditions.

Commissioning of the lighting system 100 can be carried out with commissioning apparatus that is adapted to read and write information to and from the system's gateways 110 and/or lighting fixtures 120. Each gateway 110 and lighting fixture 120 can include memory 209 that is communicatively coupled to their corresponding local controllers 455, 250. Commissioning apparatus can be implemented as a user-operated electronic device having at least a user interface and a controller (such as a microprocessor, microcontroller, field programmable gate array, application specific integrated circuit, logic circuitry, or some combination of these components). In some cases, commissioning apparatus can be implemented as a personal computer, tablet computer, smart pad, or smartphone, having commissioning software installed and executable on the device alone or in combination with another device that can interface with each gateway 110 in the system. One example of commissioning apparatus is the DMXcat® multifunction test tool, part number 6000, available from City Theatrical of New York, New York. Information about such a commissioning tool can be found online at the web address [https://www.citytheatrical.com/products/electronic/other-electronic/dmxcat-multi-function-test-tool]. The commissioning apparatus can plug into the auxiliary communication jack 119 on a gateway 110 to interface with the gateway's local controller 455. In some cases, the commissioning apparatus can wirelessly interface with the gateway's local controller 455 through an NFC transceiver 270.

Aspects of commissioning a lighting system can be using the commissioning apparatus to (1) discover lighting fixtures 120 and other controlled devices connected on the AC power lines 105 to each gateway 110, (2) assign various properties to the lighting fixtures 120 and other devices, and (3) establish and assign zones for independent lighting control. The properties of lighting fixtures that can be assigned can relate to fixture functionality, e.g., dimming curve, CCT operating range, minimum and maximum light output levels, preferred communication channel, repeater functionality etc. Further aspects of commissioning a lighting system can be transmitting standard commands (e.g., standard DMX intensity commands) to control the connected lighting fixtures 120 and ensure that the lighting fixtures are operating properly and that the channels and/or zones have been configured and are operating as desired.

### 10. Conclusion

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been described. The acts performed as part of the method may be ordered in any suitable way. Accordingly, implementations may be constructed in which acts are performed in an order different than illustrated, which may include performing some acts simultaneously, even though shown as sequential acts in illustrative implementations.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A lighting fixture for a lighting system in which intensity and color temperature of a light that is output by the lighting fixture are controllable, the lighting fixture comprising:
a light source to output the light having the intensity and the color temperature controlled by the lighting fixture;
a driver coupled to a power line to receive AC power, the driver outputting DC power to the light source;
a transceiver coupled to the power line to receive control signals from the power line, the control signals comprising a plurality of data packets; and
a controller coupled to the transceiver and to the driver, wherein the controller is configured to:
detect at least one of header information or a checksum value for a first data packet of the plurality of data packets; and
evaluate at least one of the header information or the checksum value detected for the first data packet to determine whether the first data packet is received with error or without error.

2. The lighting fixture of claim 1, wherein the controller is configured to:
ignore at least some content in the first data packet if the controller determines that at least one of the header information or the checksum value detected for the first data packet indicates that the first data packet is received with error.

3. The lighting fixture of claim 1, wherein the controller is further configured to:
determine, from the first data packet, at least a value for the color temperature of the light to be output by the light source.

4. The lighting fixture of claim 1, wherein the controller:
detects the checksum value for the first data packet; and
ignores at least some content in the first data packet if the controller determines that the checksum value indicates that the first data packet is received with error.

5. The lighting fixture of claim 1, wherein the controller:
detects the header information in the first data packet; and
ignores at least some content in the first data packet if the controller determines that the header information indicates that the first data packet is received with error.

6. The lighting fixture of claim 1, wherein the light source comprises:
a first LED source to output light having a first color temperature; and
a second LED source to output light having a second color temperature, wherein the second color temperature is different than the first color temperature.

7. The lighting fixture of claim 6, wherein the controller is further configured to:
control the driver so as to change a relative amount of current between a first current provided to the first LED source and a second current provided to the second LED source.

8. The lighting fixture of claim 7, wherein the relative amount of current is determined by setting a first pulse-width modulation of the first current and setting a second pulse-width modulation of the second current.

9. The lighting fixture of claim 1, further comprising:
a near-field communication transceiver coupled to the controller, wherein the near-field communication transceiver supports wireless communications with the lighting fixture.

10. The lighting fixture of claim 1, further comprising:
at least one sensor to detect information about a local environment in which the lighting fixture operates.

11. The lighting fixture of claim 10, wherein the at least one sensor is configured to detect at least one of motion of an object in the local environment, ambient light in the local environment, sound in the local environment, temperature in the local environment, or air-quality in the local environment.

12. A method of operating a lighting fixture for a lighting system in which intensity and color temperature of a light that is output by the lighting fixture are controlled, the method comprising:
receiving AC power and control signals for the lighting fixture from a power line;
receiving, by a transceiver of the lighting fixture, the control signals from the power line, the control signals comprising a plurality of data packets;
detecting, by a controller of the lighting fixture, at least one of header information or a checksum value for a first data packet of the plurality of data packets;
evaluating, by the controller, at least one of the header information or the checksum value detected for the first data packet to determine whether the first data packet is received with error or without error;
outputting, by a driver of the lighting fixture that is coupled to the power line to receive AC power from the power line, DC power to a light source of the lighting fixture; and
outputting, from the light source, the light having the intensity and the color temperature controlled by the lighting fixture.

13. The method of claim 12, further comprising:
ignoring, by the controller, at least some content in the first data packet if the controller determines that at least one of the header information or the checksum value indicates that the first data packet is received with error.

14. The method of claim 12, further comprising:
determining from the first data packet, by the controller, at least a value for the color temperature of the light to be output by the light source; and
operating the light source to output the light with the color temperature.

15. The method of claim 14, further comprising:
providing the DC power based, at least in part, on the value determined for the color temperature.

16. The method of claim 15, wherein providing the DC power comprises:
providing a first current from the DC power to a first LED source, the first LED source outputting first light having a first color temperature; and
providing a second current from the DC power to a second LED source, the second LED source outputting second light having a second color temperature that is different than the first color temperature.

17. The method of claim 16, further comprising:
setting a first pulse-width modulation value of the first current; and
setting a second pulse-width modulation value of the second current.

18. The method of claim 12, further comprising:
communicating wirelessly, by the lighting fixture, with a remote device, wherein the lighting fixture communicates wirelessly using a near-field communication transceiver that is coupled to the controller and mounted to the lighting fixture.

19. The method of claim 12, further comprising:
detecting, with at least one sensor mounted to the lighting fixture and coupled to the controller, information about a local environment in which the lighting fixture operates.

20. The method of claim 19, wherein the at least one sensor detects at least one of motion of an object in the local environment, ambient light in the local environment, sound in the local environment, temperature in the local environment, or air-quality in the local environment.

21. A lighting fixture for a lighting system in which intensity and color temperature of a light that is output by the lighting fixture are controllable, the lighting fixture comprising:
a light source to output the light having the intensity and the color temperature controlled by the lighting fixture;
a driver coupled to a power line to receive AC power, the driver outputting DC power to the light source;
a transceiver coupled to the power line to receive control signals from the power line, the control signals comprising a plurality of data packets; and
a controller coupled to the transceiver and to the driver, wherein the controller is configured to:
detect at least one of header information or a checksum value for a first data packet of the plurality of data packets;
evaluate at least one of the header information or the checksum value detected for the first data packet to determine whether the first data packet is received with error or without error;
receive an instruction to operate as a repeater for a plurality of lighting fixtures connected to the power line; and
retransmit at least one control signal of the control signals that are received from the power line in response to receiving the instruction to operate as a repeater.

22. The lighting fixture of claim 21, wherein retransmitting the at least one control signal improves signal communication to at least a first lighting fixture of the plurality of lighting fixtures that are connected to the power line.

23. The lighting fixture of claim 21, wherein the controller is configured to:
ignore at least some content in the first data packet if the controller determines that at least one of the header information or the checksum value detected for the first data packet indicates that the first data packet is received with error.

24. The lighting fixture of claim 21, wherein the light source comprises:
a first LED source to output light having a first color temperature; and
a second LED source to output light having a second color temperature, wherein the second color temperature is different than the first color temperature.

25. The lighting fixture of claim 24, wherein the controller is further configured to:
control the driver so as to change a relative amount of current between a first current provided to the first LED source and a second current provided to the second LED source.
